(19) United States
(12) Patent Application Publication
(10) Pub. No.: US 2019/0329234 A1
(43) Pub. Date: Oct. 31, 2019

(54) CATALYTIC METAL FIBER FELT AND ARTICLES MADE THEREFROM

(71) Applicant: BASF Corporation, Florham Park, NY (US)

(72) Inventors: Jeffrrey B. Hoke, North Brunswick, NJ (US); Oleg Ilinich, Monmouth Junction, NJ (US)

(21) Appl. No.: 16/465,707

(22) PCT Filed: Nov. 30, 2017
(86) PCT No.: PCT/IB2017/057551

§ 371 Date: May 31, 2019

Related U.S. Application Data
(60) Provisional application No. 62/428,736, filed on Dec. 1, 2016.

(51) Int. Cl. B01J 35/06; B01J 23/72; B01J 23/42; B01J 23/86; B01J 21/02; B01J 29/70; B01J 35/00; B01J 35/02; B01J 23/66; F01N 3/20; F01N 3/28; B01J 37/02; B01J 23/44; B01J 23/46

(52) U.S. Cl. CPC B01J 35/065; F01N 2330/12; B01J 23/42; B01J 23/862; B01J 21/02; B01J 29/7007; B01J 35/006; B01J 35/008; B01J 35/023; B01J 23/66; F01N 3/20; F01N 3/281; F01N 3/2835; B01J 37/0225; B01J 37/0244; B01J 37/0246; B01J 23/866; B01J 23/44; B01J 23/464; F01N 2330/10; B01J 23/72

(57) ABSTRACT

The invention provides a metal fiber felt including a woven or nonwoven mixture of fibers including a first plurality of core/shell catalytic metal fibers and an optional second plurality of reinforcing fibers, wherein the catalytic metal fibers include a core including a first metal and a shell including a catalytic metal, the catalytic metal being a noble metal, a base metal, or a combination thereof, and wherein the average diameter of the reinforcing fibers, when present, is greater than the average diameter of the catalytic metal fibers. The metal fiber felt is useful in catalytic articles for use in the abatement of pollutants in exhaust gas streams from internal combustion engines and other environmental and/or chemical catalytic processes.

### FIELD OF THE INVENTION

The present invention relates to catalytic articles useful for the treatment of exhaust gases from internal combustion engines, for utilization in chemical manufacturing processes or for treatment of other gaseous or liquid waste streams.

### BACKGROUND OF THE INVENTION

Lean burn engines, for example diesel engines, provide the user with excellent fuel economy due to their operation at high air/fuel ratios under fuel lean conditions. However, diesel engines lead to exhaust gas emissions containing particulate matter (PM), unburned hydrocarbons (HC), carbon monoxide (CO) and nitrogen oxides (NOx), wherein NOx describes various chemical species of nitrogen oxides, including nitrogen monoxide and nitrogen dioxide, among others. The two major components of exhaust particulate matter are the soluble organic fraction (SOF) and the soot fraction. The SOF condenses on the soot in layers and is generally derived from unburned diesel fuel and lubricating oils. The SOF can exist in diesel exhaust either as a vapor or as an aerosol (i.e., fine droplets of liquid condensate), depending on the temperature of the exhaust gas. Soot is predominately composed of particles of carbon.

Oxidation catalysts comprising a precious metal, such as platinum group metals (PGMs), dispersed on a refractory metal oxide support, such as alumina, are known for use in treating the exhaust of diesel engines in order to convert both hydrocarbon and carbon monoxide gaseous pollutants by catalyzing the oxidation of these pollutants to carbon dioxide and water. Such catalysts have been generally contained in units called diesel oxidation catalysts (DOC), which are placed in the exhaust flow path from diesel power systems to treat the exhaust before it vents to the atmosphere. Typically, such diesel oxidation catalysts are formed on ceramic or metallic substrates upon which one or more catalyst coating compositions are deposited. In addition to the conversion of gaseous HC and CO emissions and particulate matter (SOF portion), oxidation catalysts that contain PGM promote the oxidation of NO to NO₂. Catalysts are typically defined by their light-off temperature or the temperature at which 50% conversion is attained, also called T₅₀.

Platinum (Pt) remains the most effective platinum group metal for oxidizing CO and HC in a DOC in the presence of sulfur. After high temperature aging under lean conditions there can be an advantage to adding Pd to a Pt-based DOC, because Pd stabilizes Pt against sintering at the high temperature. One of the major advantages of using palladium (Pd) based catalysts is the lower cost of Pd compared to Pt. However, Pd-based DOCs, without Pt, typically show higher light-off temperatures for oxidation of CO and HC, especially when used with HC storage materials, potentially causing a delay in HC and or CO light-off. For this reason care must be taken to design the catalyst to maximize positive interactions while minimizing negative interactions.

Catalysts used to treat the exhaust of internal combustion engines are less effective during periods of relatively low temperature operation, such as the initial cold-start period of engine operation, because the engine exhaust is not at a temperature sufficiently high for efficient catalytic conversion of noxious components in the exhaust. To this end, it is known in the art to include an adsorbent material, which may be a zeolite, as part of a catalytic treatment system in order to adsorb gaseous pollutants, usually hydrocarbons and retain them during the initial cold-start period. As the exhaust gas temperature increases, the adsorbed hydrocarbons are driven from the adsorbent and subjected to catalytic treatment at the higher temperature.

One effective method to reduce NOₓ from the exhaust of lean-burn engines, such as gasoline direct injection and partial lean-burn engines, as well as from diesel engines, requires trapping and storing of NOₓ under lean burn engine operating conditions and reducing the trapped NOₓ under stoichiometric or rich engine operating conditions or under lean engine operation with external fuel injected in the exhaust to induce rich conditions. The lean operating cycle is typically between 1 minute and 20 minutes and the rich operating cycle is typically short (1 to 10 seconds) to preserve as much fuel as possible. To enhance NOₓ conversion efficiency, short and frequent regeneration is favored over long but less frequent regeneration. Thus, a lean NOₓ trap catalyst generally must provide a NOₓ trapping function and a three-way conversion function.

Some lean NOₓ trap (LNT) systems contain alkaline earth elements. For example, NOₓ sorbent components include alkaline earth metal oxides, such as oxides of Mg, Ca, Sr or Ba. Other lean LNT systems can contain rare earth metal oxides such as oxides of Ce, La, Pr or Nd. The NOₓ sorbents can be used in combination with platinum group metal catalysts such as platinum dispersed on an alumina support for catalytic NOₓ oxidation and reduction. The LNT catalyst operates under cyclic lean (trapping mode) and rich (regeneration mode) exhaust conditions during which the engine out NO is converted to N₂.

Another effective method to reduce NOₓ from the exhaust of lean-burn engines requires reaction of NOₓ under lean burn engine operating conditions with a suitable reductant such as ammonia or hydrocarbon in the presence of a selective catalytic reduction (SCR) catalyst. Suitable SCR catalysts include metal-containing molecular sieves such as metal-containing zeolites. A useful SCR catalyst component is able to effectively catalyze the reduction of the NOx exhaust component at temperatures below 600° C., so that reduced NOx levels can be achieved even under conditions of low load, which typically are associated with lower exhaust temperatures.

These observations, in conjunction with emissions regulations becoming more stringent, have driven the need for developing emission gas treatment systems with improved CO, HC and NO oxidation capacity to manage CO, HC and NO emissions at low engine exhaust temperatures. In addition, development of emission gas treatment systems for the reduction of NOₓ (NO and NO₂) emissions to nitrogen has become increasingly important.

### SUMMARY OF THE INVENTION

This present disclosure describes a catalytic metal fiber which comprises a core comprising a first metal, such as one selected from the group consisting of aluminum, aluminum alloy, copper, copper alloy, stainless steel, nickel, nickel/chromium alloy, iron/chromium alloy and noble metals and a shell comprising a catalytic metal, such as one selected from the group consisting of noble metals. Also disclosed is a metal fiber felt comprising catalytic metal fibers which comprise a core comprising a first metal selected, for example, from the group consisting of aluminum, aluminum alloy, copper, copper alloy, stainless steel, nickel, nickel/chromium alloy, iron/chromium alloy and noble metals and a shell comprising a catalytic metal selected, for example, from the group consisting of noble metals.

Also disclosed is a catalyst article comprising a metal fiber felt as disclosed herein. Also disclosed is an exhaust gas treatment system comprising a catalyst article as disclosed herein, and a method for treating an exhaust gas stream, comprising passing the exhaust stream through an article or a system as described herein. Also disclosed is a catalytic system for chemical processes in manufacturing and/or environment protection comprising a catalyst article comprising a metal fiber felt as disclosed herein. Still further, the disclosure relates to a method for chemical processes in manufacturing and/or environment protection, comprising passing a liquid or gaseous stream through an article or a system as described herein.

The present disclosure includes, without limitation, the following embodiments:

### Embodiment 1

A metal fiber felt comprising a woven or nonwoven mixture of fibers in the form of a corrugated felt comprising a first plurality of core/shell catalytic metal fibers, wherein the catalytic metal fibers comprise a core comprising a first metal and a shell comprising a catalytic metal, the catalytic metal being a noble metal, a base metal, or a combination thereof

### Embodiment 2

The metal fiber felt of any preceding embodiment, wherein the mixture of fibers further comprises a second plurality of reinforcing fibers, wherein the average diameter of the reinforcing fibers is greater than the average diameter of the catalytic metal fibers.

### Embodiment 3

The metal fiber felt of any preceding embodiment, wherein the average diameter of the catalytic metal fibers is about 10 microns or less and the average diameter of the reinforcing fibers is about 15 microns or greater.

### Embodiment 4

The metal fiber felt of any preceding embodiment, wherein the average diameter of the catalytic metal fibers is about 5 microns or less and the average diameter of the reinforcing fibers is about 20 microns or greater.

### Embodiment 5

The metal fiber felt of any preceding embodiment, wherein the first metal is selected from the group consisting of aluminum, aluminum alloy, copper, copper alloy, stainless steel, nickel, nickel/chromium alloy, iron/chromium alloy, and noble metals.

### Embodiment 6

The metal fiber felt of any preceding embodiment, wherein the reinforcing fibers comprise a metal selected from the group consisting of aluminum, aluminum alloy, copper, copper alloy, stainless steel, nickel, nickel/chromium alloy, and iron/chromium alloy.

### Embodiment 7

The metal fiber felt of any preceding embodiment, wherein the shell of the catalytic fibers have an average thickness of about 100 nm or less.

### Embodiment 8

The metal fiber felt of any preceding embodiment, wherein the shell of the catalytic fibers comprise a base metal and a noble metal.

### Embodiment 9

The metal fiber felt of any preceding embodiment, wherein the base metal is selected from the group consisting of Cu, Fe, Ni, Cr, Mo, Mn, Zn, Co, W, and Al.

### Embodiment 10

The metal fiber felt of any preceding embodiment, wherein the plurality of catalytic metal fibers comprises a first group of fibers having a shell comprising a first noble metal and a second group of fibers having a shell comprising a second noble metal.

### Embodiment 11

The metal fiber felt of any preceding embodiment, wherein the first noble metal is Rh and the second noble metal is Pd.

### Embodiment 12

The metal fiber felt of any preceding embodiment, wherein the noble metal is selected from the group consisting of Pt, Pd, Rh, and mixtures thereof.

### Embodiment 13

The metal fiber felt of any preceding embodiment, wherein the metal fiber felt has a void volume of about 20% to about 95%.

### Embodiment 14

The metal fiber felt of any preceding embodiment, further comprising a catalytic and/or sorbent coating carried by the mixture of fibers.

### Embodiment 15

The metal fiber felt of any preceding embodiment, wherein the metal fiber felt is substantially free of added catalytic coating or sorbent coating.

### Embodiment 16

A catalytic article comprising a three dimensional matrix comprising a plurality of layers of a metal fiber felt according to any preceding embodiment.

### Embodiment 17

The catalytic article of any preceding embodiment, wherein the three dimensional matrix comprises a plurality of corrugated layers of the metal fiber felt with flat metal layers therebetween.

### Embodiment 18

The catalytic article of any preceding embodiment, wherein at least one of the metal fiber felt layers or the flat metal layers carries a catalytic coating or sorbent coating.

### Embodiment 19

The catalytic article of any preceding embodiment, wherein the flat metal layers are either also formed of the metal fiber felt or formed of a metal foil.

### Embodiment 20

The catalytic article of any preceding embodiment, further comprising a jacket encasing the three dimensional matrix therein.

### Embodiment 21

The catalytic article of any preceding embodiment, having a cell density of from about 60 cells per square inch (cpsi) to about 900 cpsi.

### Embodiment 22

The catalytic article of any preceding embodiment, in the form of a flow-through article or a wall-flow filter.

### Embodiment 23

The catalytic article of any preceding embodiment, further comprising a heating element operatively positioned to heat the three dimensional matrix or electrical terminals electrically connected to at least one component of the catalytic article and adapted to deliver current for resistive heating of the catalytic article.

### Embodiment 24

An exhaust gas treatment system comprising the catalytic article of any preceding embodiment downstream of, and in fluid communication with, an internal combustion engine.

### Embodiment 25

The exhaust gas treatment system of any preceding embodiment, wherein the catalytic article is selected from the group consisting of a diesel oxidation catalyst, a selective reduction catalyst, a lean NOx trap, a three-way catalyst, and an ammonia oxidation catalyst.

### Embodiment 26

A method for treating an exhaust gas stream, comprising passing the exhaust stream through a metal fiber felt according to any preceding embodiment.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure or recited in any one or more of the claims, regardless of whether such features or elements are expressly combined or otherwise recited in a specific embodiment description or claim herein. This disclosure is intended to be read holistically such that any separable features or elements of the disclosure, in any of its aspects and embodiments, should be viewed as intended to be combinable, unless the context of the disclosure clearly dictates otherwise.

### BRIEF DESCRIPTION OF THE FIGURES

In order to provide an understanding of embodiments of the invention, reference is made to the appended drawings, which are not necessarily drawn to scale, and in which reference numerals refer to components of exemplary embodiments of the invention. The drawings are exemplary only, and should not be construed as limiting the invention.

FIG. 1 is a cross-sectional view of a catalytic metal fiber according to the invention;

FIG. 2a is a perspective view of a catalytic article according to one embodiment of the invention;

FIGS. 2b and 2c are enlarged views of a portion of the catalytic article of FIG. 2a;

FIGS. 3a-3d illustrate exemplary cross-sectional shapes for a corrugated metal fiber felt of the invention;

FIG. 4 illustrates an electrically heated catalytic article according to one embodiment of the invention; and

FIG. 5 illustrates an exemplary emission treatment system comprising the metal fiber felt of the invention.

### DETAILED DESCRIPTION OF THE INVENTION

The term “exhaust stream” or “exhaust gas stream” refers to any combination of flowing gas that may also contain solid or liquid particulate matter. The stream comprises gaseous components which may contain certain non-gaseous components such as liquid droplets, solid particulates and the like. An exhaust stream of an internal combustion engine typically further comprises combustion products, products of incomplete combustion, oxides of nitrogen, combustible and/or carbonaceous particulate matter (soot) and un-reacted oxygen and/or nitrogen.

The term “industrial waste water” refers to water that has been used and contains dissolved or suspended waste materials.

The term “chemical process” refers to a method intended to be used in manufacturing or on an industrial scale to change the composition of chemical(s) or material(s), usually using technology similar or related to that used in chemical plants or the chemical industry.

The term “catalytic article” refers to an element that is used to promote a desired reaction.

The term “functional article” refers to an element that is used to promote a desired reaction and/or to provide a sorbent function; that is, containing one or more catalyst and/or sorbent compositions.

The term “essentially the same” means for example within a tolerance of ±6%, ±5%, ±4%, ±3%, ±2%, ±1%, ±0.5%, ±0.4%, ±0.3%, ±0.2%, ±0.1% or ±0.05%.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±5%, ±4%, ±3%, ±2%, ±1%, ±0.5%, ±0.4%, ±0.3%, ±0.2%, ±0.1% or ±0.05%. All numeric values are modified by the term “about” whether or not explicitly indicated. Numeric values modified by the term “about” include the specific identified value. For example “about 5.0” includes 5.0.

“Noble metal components” refer to noble metals or compounds thereof, such as oxides. Noble metals are ruthenium, rhodium, palladium, silver, osmium, iridium, platinum and gold.

“Platinum group metal components” refer to platinum group metals or compounds thereof, for example oxides. Platinum group metals are ruthenium, rhodium, palladium, osmium, iridium and platinum.

Noble metal components and platinum group metal components also refer to any compound, complex or the like, which, upon calcinations or use thereof, decomposes or otherwise converts to a catalytically active form, usually the metal or the metal oxide.

### Catalytic Metal Fibers

The catalytic metal fibers of the present invention having a core/shell or cladded structure may be prepared for instance by methods disclosed in U.S. Pub. App. No. 2015/0118599 to Bevk, which is incorporated by reference herein. For example, an initial composite fiber including a core and shell (cladding) is cut into smaller pieces or is first mechanically reduced and then cut into smaller pieces. The smaller pieces may be inserted into a metal matrix and the entire structure further reduced mechanically in a series of reduction steps. The process may be repeated until the desired filament size is obtained. The matrix may then be chemically removed exposing the individual cladded filaments.

The initial composite fiber may be formed by inserting a rod of the core material into a tube of the shell material, or alternatively, the rod of the core material may be wrapped with a foil layer of the shell material. Mechanical reduction includes swaging, drawing, extrusion, rolling and the like.

The catalytically active cladded metal fibers of the present invention may have a core diameter of from about 1 μm, about 2 μm or about 3 μm to about 4 μm, about 5 μm, about 6 μm, about 7 μm, about 8 μm, about 9 μm or about 10 μm, on average. In other embodiments, the core may have an average diameter of from about 10 μm, about 20 μm, about 30 μm, about 40 μm, about 50 μm or about 60 μm to about 70 μm, about 80 μm, about 90 μm, about 100 μm, about 110 μm, about 120 μm, about 130 μm, about 140 μm or about 150 μm. As the shell thickness is nano-scaled, these core diameter ranges also represent the average diameter of the finished cladded fibers or filaments. Due to the small diameter, the catalytically active cladded metal fibers of the present invention have high external geometric surface area and therefore high catalytic surface area for contacting exhaust gases.

The metal used in the core of the fiber can be, for instance, selected from the group consisting of aluminum, aluminum alloy, copper, copper alloy, stainless steel, nickel, nickel/chromium alloy, iron/chromium alloy and noble metals. The shell (cladding) advantageously comprises a catalytically active metal component selected from the group consisting of Pt, Pd, Rh, Au, Ag, Ru, Ir and alloys thereof. For instance, the shell comprises Pt, Pd, Rh or alloys thereof. The shell may comprise a single applied cladding layer. Alternatively, the shell may comprise multiple applied layers which may comprise different metals, for instance, a layer of Pd over a layer of Pt or a layer of Pt over a layer of Pd. Other possible combinations include but are not limited to a layer of Rh over a layer of Pd, a layer of Pd over a layer of Rh, a layer of Au over a layer of Pd, a layer of Pd over a layer of Au, a layer of Pt over a layer of Rh, a layer of Rh over a layer of Pt and the like. Multiple layers include more than one, for instance 2, 3 or 4 layers.

The catalytically active cladded metal fibers of the present invention may have a shell (cladding) thickness for example from about 1 nm, about 2 nm or about 3 nm to about 4 nm, about 5 nm, about 6 nm, about 7 nm, about 8 nm, about 9 nm or about 10 nm thick, on average. In other embodiments, the shell may have an average thickness of from about 10 nm, about 20 nm, about 30 nm or about 40 nm to about 50 nm, about 60 nm, about 70 nm, about 80 nm, about 90 nm or about 100 nm. The shell may be continuous, covering the entire core. In some embodiments of the invention, the shell or cladding is not continuous and does not cover the core in all places. The average thickness is over the entire fiber. Larger cladding thicknesses, for example 20 nm or above, are suitable for instance where the cladding contains Ag or Ru.

The weight percent of the shell (cladding) comprising a noble metal (and/or base metal as described below) may be from about 0.01% to about 2.0%, based on the total weight of the cladded metal fibers. For example, the shell may be from about 0.02 wt %, about 0.04 wt %, about 0.06 wt %, about 0.08 wt % or about 0.1 wt % to about 0.14 wt %, about 0.18 wt %, about 0.22 wt %, about 0.25 wt %, about 0.35 wt %, about 0.42 wt %, about 0.46 wt %, about 0.50 wt %, about 0.55 wt %, about 0.65 wt %, about 0.75 wt %, about 1.0 wt %, about 1.25 wt %, about 1.5 wt %, about 1.75 wt % or about 2.0 wt %, based on the total weight of the cladded metal fibers.

In other embodiments of the invention, the cladding may also comprise a base metal component, which can be used as the sole catalytically active metal, or used in combination with a noble metal. Base metals may include, but are not limited to, Cu, Fe, Ni, Cr, Mo, Mn, Zn Co, W and aluminum. In some embodiments, the base metal component may be included with the noble metal during manufacture of the cladded filament or it may naturally combine (alloy) with the noble metal under normal operating conditions to which the cladded filaments are exposed. In particular, base metals from the core of the filament may migrate into (alloy with) the noble metal cladding during exposure of the cladded filaments to high temperatures. For example, a filament comprising a Ni core and a Pt shell may transform into a filament comprising a Ni core and a PtNi shell after exposure to high temperature. Depending on the composition of the core, the composition of the shell and the conditions of high temperature exposure (e.g., temperature, time and ambient environment), an infinite number of alloy structures and compositions are possible.

Also included within the scope of the invention are multiple cladding layers comprising both noble and base metals, for example, a layer of Cu over a layer of Pt, a layer of Pt over a layer of Cu, a layer of Cu over a layer of Pd, a layer of Pd over a layer of Cu, a layer of Ni over a layer of Pt, a layer of Pt over a layer of Ni, a layer of Fe over a layer of Pt, a layer of Pt over a layer of Ni and the like. More than two cladding layers are also possible, such as three, four or five layers.

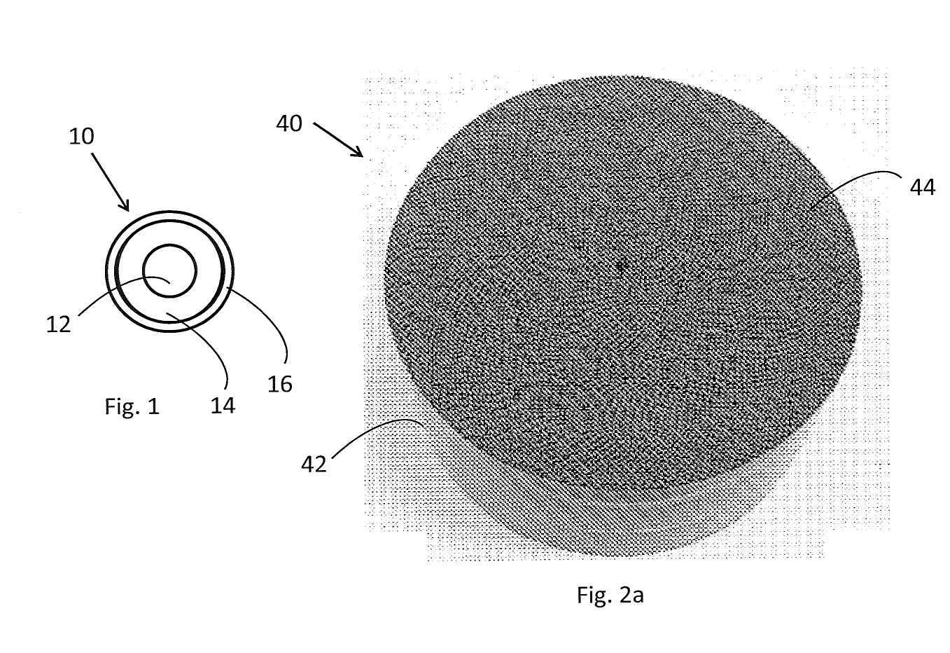

An exemplary cross-sectional view of a catalytic metal fiber 10 utilized in the present invention is set forth in FIG. 1, which shows a metal core 12 surrounded by a first cladding layer 14 and an optional second cladding layer 16.

### Metal Fiber Felt

In one embodiment of the invention, the cladded filaments may be incorporated along with non-catalytic reinforcing structural fibers into a metal fiber felt. These structural reinforcing fibers or filaments are for example from about 1 μm, about 2 μm, about 3 μm, about 4 μm, about 5 μm, about 6 μm, about 7 μm, about 8 μm, about 9 μm or about 10 μm to about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 30 μm, about 35 μm, about 40 μm, about 45 μm, about 50 μm, about 60 μm, about 70 μm, about 80 μm, about 90 μm, about 100 μm, about 120 μm, about 130 μm or about 150 μm in diameter, on average. In one embodiment, the reinforcing fibers are on average larger in diameter than the catalytic fibers. The reinforcing structural fibers of the metal fiber felt may be uniform, having essentially the same average diameter or alternatively, may have a range of varying sizes, lengths and shapes.

The metal of the structural reinforcing filaments of the metal fiber felt is an elemental metal or a metal alloy, for example, Al, an Al alloy, Cu, a Cu alloy, Ni, a NiCr alloy, stainless steel or a FeCr alloy. The key requirement is that the metals or alloys have sufficient stability to allow manufacture of the metal felt while maintaining its physical integrity. The composition of the reinforcing filaments is also dependent on the environment in which the filaments will be used. For example, aluminum and copper are particularly suited for use at low temperatures, such as less than 500-600° C. whereas other metals and alloys with high temperature and oxidation resistance such as FeCr and NiCr alloys are more suitable for use at higher temperatures.

A suitable and commercially available stainless steel metal alloy is identified as Haynes 214 alloy. This alloy and other useful nickeliferous alloys are described for example in U.S. Pat. No. 4,671,931 to Herchenroeder et al., which is incorporated herein by reference. These alloys are characterized by high resistance to oxidation and high temperatures. A specific example contains about 75% nickel, about 16% chromium, about 4.5% aluminum, about 3% iron, optionally trace amounts of one or more rare earth metals except yttrium, about 0.05% carbon and steel making impurities, by weight. Haynes 230 alloy, also useful herein has a composition containing about 22% chromium, about 14% tungsten, about 2% molybdenum, about 0.10% carbon, a trace amount of lanthanum, balance nickel, by weight.

Suitable alloys also include those in which iron is a substantial or major component, for example FeCr alloys and ferritic stainless steels. FeCr alloys may contain one or more of nickel, chromium and aluminum and the total of these metals may advantageously comprise at least about 15 wt % (weight percent) of the alloy, for instance, about 10 to about 25 wt % chromium, about 1 to about 8 wt % of aluminum and from 0 to about 20 wt % of nickel, balance iron. FeCr alloys include FeCrAl alloys, which contain for example from about 10 to about 25 wt % chromium, from about 3 to about 8 wt % aluminum, optional trace amounts of a rare earth metal and/or another transition metal and balance iron. A suitable FeCrAl alloy is Fecralloy®, an alloy, by weight, of Fe 72.8/Cr 22/A15/Y 0.1/Zr 0.1.

Also suitable is “ferritic” stainless steel such as that described in U.S. Pat. No. 4,414,023 to Aggen et al, which is incorporated by reference herein. An example of a suitable ferritic stainless steel alloy contains about 20% chromium, about 5% aluminum and from about 0.002% to about 0.05% of at least one rare earth metal selected from cerium, lanthanum, neodymium, yttrium and praseodymium or a mixture of two or more of such rare earth metals, balance iron and trace steel making impurities, by weight.

The ferritic stainless steels and the Haynes alloys 214 and 230, all of which are considered to be stainless steels, are examples of high temperature resistive, oxidation resistant (or corrosion resistant) metal alloys that are useful in the present invention.

Aluminum alloys may contain for example one or more of copper, zinc, magnesium, manganese, silicon or tin. Copper alloys may contain for example one or more of zinc, tin, aluminum, silicon, nickel, iron or manganese.

Suitable metal alloys for use in this invention should, for example, be able to withstand “high” temperatures, e.g., from about 500° C. to about 1200° C. (about 932° F. to about 2012° F.) over prolonged periods. Other high temperature resistive, oxidation resistant metal alloys are known and may be suitable.

The metal of the core of the core/shell catalytic fibers and the metal of the reinforcing filaments may be the same or different. Any metals described herein suitable for reinforcing filaments may also be suitable for the core and vice versa. Also included are noble metals, for example, silver or ruthenium. The key requirement is that the metals or alloys of the core and cladding have sufficient compatibility to allow manufacture of the cladded filaments while maintaining the physical integrity of both the core and cladding. If the cladded filaments are prepared by mechanical reduction techniques, the core metal advantageously has mechanical properties compatible with the platinum group metal cladding. Examples include Ni, NiCr alloys, Cu and noble metals including Ag and Ru. The composition of the core is also dependent on the environment in which the filaments will be used. For example, aluminum, copper and silver would be particularly suited for use at low temperatures, such as less than 500-600° C. whereas other metals and alloys with high temperature and oxidation resistance such as FeCr alloys are more suitable for use at higher temperatures.

The weight ratio of cladded fibers to reinforcing structural fibers combined in a metal felt substrate of the present invention depends on many factors including, but not limited to, the composition and density of the cladded (catalytic) fibers, the composition and density of the structural fibers, the thickness of the cladded (catalytic) fibers, the thickness of the reinforcing structural fibers, the thickness of the cladding (catalytic metal) and the amount (weight) of cladding metal needed to accomplish sufficient exhaust gas treatment. For example, catalytic fibers may comprise from about 5 to 100 wt % (weight percent) of the total weight of the metal felt including reinforcing fibers. For instance, the weight ratio of catalytic fibers to reinforcing fibers in a metal felt is from about 1:20, about 1:15, about 1:10, about 1:5 or about 1:2 to about 2:1, about 5:1, about 10:1, about 15:1 or about 20:1 (e.g., about 1:1).

A key advantage of the present invention is that the cladded fibers or filaments are catalytic due to the availability of catalytically active metals on the fiber or filament surface. When incorporated into a metal fiber felt and subsequently assembled into a three dimensional monolithic structure (metal fiber felt substrate), the structure itself functions as a catalyst without the need for application of catalytic coatings commonly known in the art. The absence of a further added catalyst composition provides benefits including low backpressure, fast diffusion of exhaust gases to the catalytic metal shell and good long-term sulfur resistance. Further, the metal fiber felt will allow for on-demand and rapid electrical resistive heating during low temperature exhaust conditions such as cold-start conditions.

In another embodiment of the invention, the cladded fibers are thick enough to provide sufficient structural stability to be incorporated into the metal fiber felt without the need for additional reinforcing fibers. For example, such suitable average diameters for cladded fibers is from about 5 μm, about 7 μm, about 10 μm, about 15 μm, about 20 μm or about 25 μm to about 30 μm, about 35 μm, about 40 μm or about 50 μm. For example, in one embodiment, a relatively thick cladded fiber (e.g., cladded fibers having an average diameter of greater than 5 μm or greater than 10 μm or greater than 15 μm or greater than 20 μm) is used in the absence of reinforcing fibers or substantially free of reinforcing fibers. In this embodiment, the relatively thick cladded fibers can include at least one base metal as noted above in the cladding, and the cladding can be substantially free of noble metal or optionally contain noble metal.

The metal fiber felt useful in the present invention may comprise an intertwined random array of non-woven cladded fibers or filaments and optionally structural reinforcing fibers or filaments. Alternatively, the metal fiber felt may comprise woven fibers or filaments. In another embodiment, the structural fibers are woven while the cladded fibers are nonwoven. In another embodiment, the structural reinforcing fibers are nonwoven while the cladded fibers are woven.

A suitable metal fiber felt may be from about 50 μm, about 75 μm, about 100 μm, about 125 μm, about 150 μm, about 175 μm, about 200 μm or about 225 μm to about 250 μm, about 275 μm, about 300 μm, about 325 μm, about 350 μm, about 375 μm, about 400 μm, about 425 μm, about 450 μm, about 475 μm or about 500 μm thick on average. The metal fiber felt may alternatively be much thicker, for instance from about 200 μm to about 1 inch (25,400 μm), for example from about 300 μm to about 20,000 μm, from about 400 μm to about 18,000 μm, from about 500 μm to about 15,000 μm or from about 600 μm to about 12,000 μm thick on average.

The metal fiber felt is highly porous and thereby exhibits a high degree of void volume (voids) or “empty space” throughout its thickness. For instance, the void volume of the metal fiber felt is from about 20%, about 25%, about 30%, about 35%, about 40%, about 45%, about 50% or about 55% to about 60%, about 65%, about 70%, about 75%, about 80%, about 85%, about 90% or about 95% of the total volume of the metal felt, on average. This void volume is prior to the application of any catalytic or sorbent composition (functional composition), further discussed below. In some embodiments, the void volume can be about 20% to about 95% or about 50% to about 95% of the total volume of the metal felt, on average prior to being treated/loaded with a catalyst and/or sorbent composition.

It is not critical by what process the metal fiber felts are prepared as long as the integrity of the cladded filaments is preserved and the filaments are otherwise not degraded or destroyed. Metal fiber felts are prepared, for example, by a process comprising sintering metal fibers under compression. Methods are taught, for example, in U.S. Pub. App. No. 2011/0209451 to Kotthoff et al., which is incorporated by reference herein.

### Catalytic Article

In an additional embodiment of the invention, the metal fiber felt comprising the cladded filaments can be stacked, coiled, wound or folded, providing a three dimensional structure with a plurality of metal fiber felt layers. In addition, the stacked, coiled, wound or folded metal fiber felt having corrugation will provide a three dimensional structure with a plurality of metal fiber felt layers and a plurality of channels (gas flow passages) extending there through from an inlet face to an outlet face of the structure such that passages are open to fluid flow there through. The channel walls comprising the fiber felt provide high geometric surface area for flowing gas to contact the catalytic fibers incorporated therein. Even without corrugation, the porosity of the metal fiber felt will create a plurality of random and tortuous gas flow passages from the inlet face to the outlet face of the three dimensional structure. Corrugated layers may also be separated by flat layers in-between referred to as secluding layers. The three dimensional structure comprising the metal fiber felt can also be referred to as a metal fiber felt substrate.

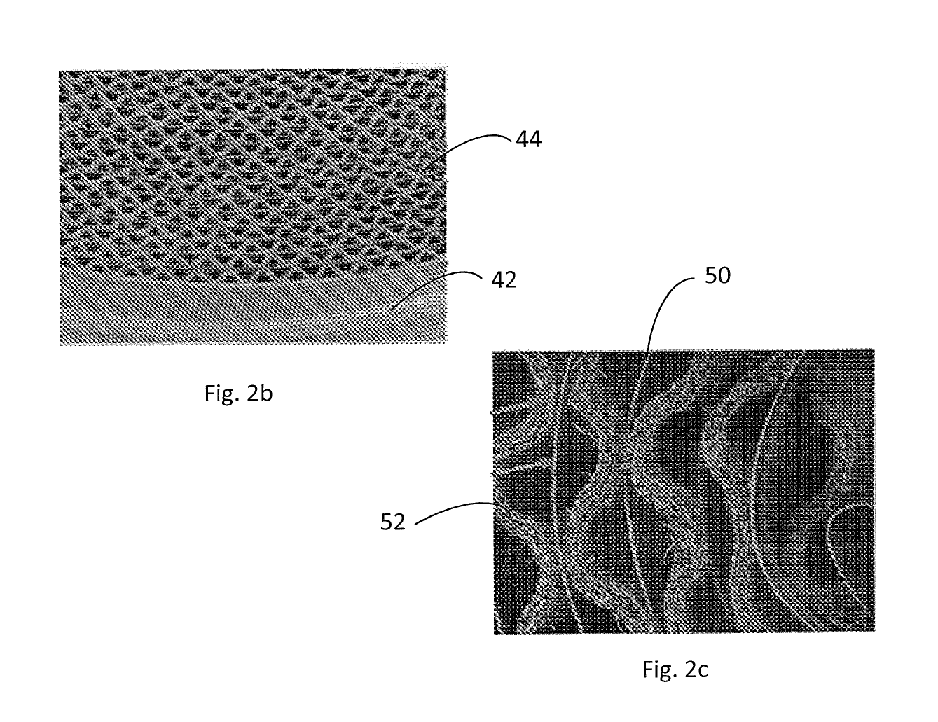

One embodiment of a catalytic article 40 comprising a plurality of layers 44 of metal fiber felt encased within a metal jacket or mantle 42 is shown in FIG. 2a and FIG. 2b. FIG. 2c shows a further enlarged view of FIG. 2a such that the multiple layers of coiled corrugated metal felt 52 of the invention can be seen with intervening secluding layers of metal foil 50. An exemplary catalytic article of the type shown in FIG. 2a has a diameter of 5.66″, a length of 3″ and a nominal channel density of 400 cpsi.

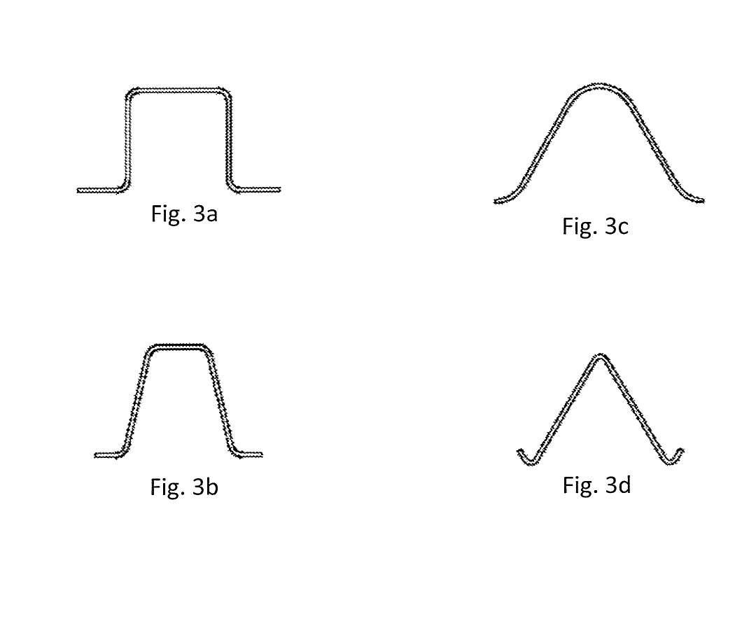

The metal fiber felt comprising the cladded filaments of the present invention may be flat, without any applied surface structure. Alternatively, in another embodiment of the invention, the metal fiber felt may advantageously be corrugated. Corrugation may be accomplished with traditional means/equipment. Various non-limiting corrugation shapes are shown in FIGS. 3a-3d.

The catalytic articles comprising the metal fiber felt substrate comprising the cladded filaments have an inlet end, an outlet end, an axial length and an axial width. The inlet end of an article is synonymous with the “upstream” end or “front” end. The outlet end is synonymous with the “downstream” end or “rear” end. The upstream end is towards the source of exhaust gas, for example an internal combustion engine.

In the present articles, both the corrugated layers and secluding layers may comprise the metal fiber felt. Alternatively, the corrugated layers may comprise the metal fiber felt and the secluding layers may comprise metal foils; or the corrugated layers may comprise metal foils and the secluding layers may comprise the metal fiber felt.

Secluding foils are for example flat foils, flat foils with etch-holes or micro-ripple foils commonly known in the art. Secluding foils are additional supporting foils between corrugated metal layers, for example, corrugated metal fiber felt layers. Flat secluding foils have a thickness, for example, from about 10 μm to about 150 μm, or from about 25 μm to about 125 μm, or from about 40 μm to about 95 μm.

The stacked, coiled, wound or folded compositions comprising a plurality of metal felt layers provide a stacked, coiled, wound or folded matrix having a three dimensional structure. The matrix may be inserted into a metal jacket or mantle as shown in FIG. 2a and the periphery of the matrix may be joined to the mantle interior. The metal layers may be fused together by brazing. The channel openings are clearly visible in FIGS. 2b and 2c.

Depending on the processing conditions of corrugation, the channels formed by the stacked, coiled, wound or folded compositions can have various sizes or shapes such as trapezoidal, rectangular, square, sinusoidal, hexagonal, etc. Typically, the articles of the present invention have a cell (channel) density of from about 60 cells per square inch (cpsi) of cross sectional area perpendicular to the gas flow to about 500 cpsi, or up to about 900 cpsi, for example, from about 200 to about 400 cpsi.

Unlike conventional ceramic or metal foil substrates where a functional catalyst or adsorbent composition coated thereon is contacted by exhaust gas from only one side due to the presence of the impermeable substrate wall, the porous wall of the metal fiber felt substrate of the present invention allows contact of the cladded fibers and filaments incorporated within the felt with exhaust gases from both sides of the felt. This minimizes diffusion limitations of gaseous pollutants to the cladded filament surface and also reduces pressure drop of the functional article. For the metal fiber felt of a sufficiently high void volume fraction, exhaust gases can travel down the open channels and also within the porous walls of the channels, thereby minimizing the diffusion limitation even further.

In one embodiment of the invention, filaments comprising different claddings may be combined in the same fiber felt. This may enable the felt to accomplish multiple catalytic functions such as CO and hydrocarbon oxidation and NOx reduction. For example, filaments comprising a Pd cladding may be combined with filaments comprising a Rh cladding such that Pd and Rh clad filaments are uniformly distributed throughout the felt and are in close proximity to each other. Alternatively, the Pd and Rh clad filaments could be segregated to different regions of the felt during manufacture. When the felt is stacked, coiled, wound or folded into a three dimension structure, such as a metal fiber felt monolith, the fibers with different claddings may be uniformly distributed throughout the width and length of the structure or they may be segregated to specific regions. For example, filaments with one cladding may be segregated to the inlet end of the structure while filaments with a different cladding may be segregated to the outlet end.

Accordingly, the catalytic articles comprising the metal fiber felts may be “zoned”, having a certain catalytic function towards one end and another catalytic function towards the other end. The “zones” may be any axial length of the article, for example from about 5%, about 10%, about 15%, about 20%, about 25%, about 30%, about 35%, about 40%, about 45% or about 50% to about 55%, about 60%, about 65%, about 70%, about 75%, about 80%, about 85%, about 90% or about 95% of the axial length.

The metal fiber felt may comprise at least two different catalytic fibers. The at least two different catalytic fibers may be in any weight ratio in a metal fiber felt, for example from about 1:20, about 1:15, about 1:10, about 1:5 or about 1:2 to about 2:1, about 5:1, about 10:1, about 15:1 or about 20:1 (e.g., about 1:1).

In one embodiment of the invention, the catalytic shell metal may be applied to a core fiber by methods including electroplating and electroless deposition. This could be accomplished on individual fibers or filaments or on a collection of fibers and filaments incorporated into a metal fiber felt. Alternatively, the shell material could be applied to the fibers of a metal felt after corrugation (optional) and subsequent stacking, coiling, winding or folding the felt into a three dimensional structure (metal felt substrate). As such, the cladded fibers may be uniform, having essentially the same average diameter or alternatively, may have a range of varying sizes, lengths and shapes.

The present catalyst articles are suitable for electrical heating. An electrically heated catalyst for instance contains a heating coil or heating element inside a catalytic converter assembly. The heating coils or elements are activated with electrical energy. For instance, the heating coils or elements are electrified just after the engine is started, bringing the catalyst up to operating temperature much faster than normally accomplished by engine exhaust. Because the cladded filaments of the present invention are themselves comprised of metal, they can also function directly as the heating element when activated with electrical energy resulting in very fast heating of the catalytically active cladding on the filament surface. When combined with other structural metal fibers in a metal felt and subsequently formed into a three dimensional metal felt substrate, the entire substrate including both cladded and structural filaments will function as a heating element providing fast heat-up and light-off of the catalytic filaments and optionally applied coated compositions.

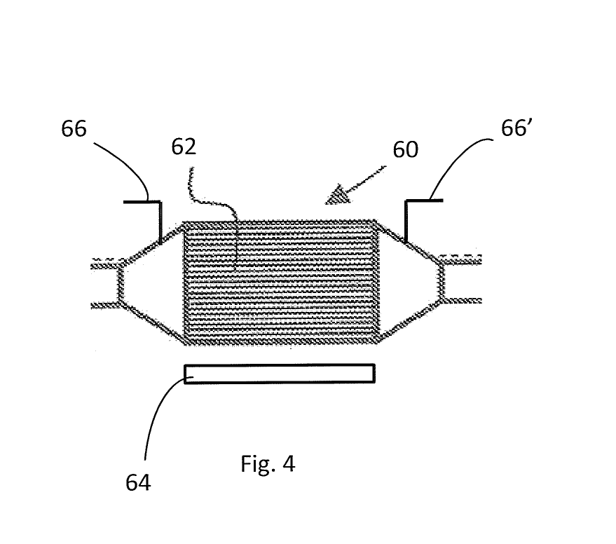

An “electrically heated catalyst article” means that one or more heating coils or elements are associated therewith. The present catalyst articles may have one or more heating coils or elements associated therewith. Alternatively, present catalyst articles may themselves be suitable as an electrically heated catalyst article without any additional heating coils or elements. For instance, a present catalyst article may comprise electrical terminals across which a voltage can be applied in order to electrically heat the article (electric resistive heating). See, for example, FIG. 4, which illustrates a catalytic article 60 containing a plurality of layers of a metal felt 62 according to the invention, and also having a heating element 64 proximal to the exterior of the catalytic article for heating of the catalytic article. The heating element 64 would be operatively connected to a power source (not shown), such as a battery, for delivery of power to the heating element. Alternatively, the catalytic article 60 could include electrical terminals, 66 and 66′, for delivery of current directly to the catalytic article 60 from a power source (not shown), such as a battery, such that the article itself provides resistive heating. Both source of heating are shown in the same embodiment of FIG. 4 for the sake of brevity, but would typically not be employed together.

### Catalytic or Sorptive Coatings

In certain embodiments of the invention, however, it may be advantageous to further include a functional coating composition comprising a catalytic or sorptive composition disposed on the fibers and within the voids of the metal fiber felt substrate thereof. In one embodiment, the functional coating can comprise a catalytic composition. In another embodiment the functional coating can comprise a sorptive composition. Functional coatings comprising both catalytic and sorptive compositions are also included.

The catalyst and/or sorbent composition of certain embodiments is disposed on the metal fibers and is in adherence thereto. The catalyst and/or sorbent composition is also within the voids of the porous metal fiber felt (occupies the voids). The catalyst and/or sorbent composition within the voids is in adherence to the metal fibers or filaments. The catalyst and/or sorbent composition may be disposed on metal fibers towards the interior of the felt and/or on metal fibers at the felt surface. Thus, the catalyst and/or sorbent composition may be distributed throughout the interior of the fiber felt and may also be disposed on the surface of the fiber felt.

A catalyst and/or sorbent composition may also be applied separately to the metal felts and/or secluding metal foils of the present articles prior to stacking, coiling, winding or folding into a three dimensional structure. The catalyst and/or sorbent composition deposited on the metal foil may be the same or different than that disposed within the metal fiber felt. Additionally, the metal fiber felt may contain no added catalyst composition (no catalytic coating) and any metal foil secluding layers may contain a catalytic coating. The secluding layer may comprise either a metal foil or a metal felt.

The catalyst and/or sorbent compositions present in metal felt voids, on a metal felt surface or on a metal foil surface may be referred to herein as “functional coatings,” and more specifically, as “catalytic coatings” or “sorbent coatings.”

The catalyst composition of certain embodiments of the present invention comprises a catalytically active metal and a support. The catalytically active metal is a base metal such as Fe, Cu, Ni, Zn, Mn, Mo, V or Co or is a noble metal, for example a platinum group metal. For example, present catalyst compositions useful for treating gaseous pollutants comprise a platinum group metal (PGM), for instance platinum, palladium or rhodium on support particles. A platinum group metal component may comprise a mixture of platinum and palladium, for instance at a weight ratio of from about 1:10 to about 10:1, for example from about 1:5 to about 5:1. The active metals may be present as elemental metal or as a metal compound, typically an oxide compound.

A catalyst and/or sorbent composition may comprise one or more supports (refractory inorganic solid oxide porous powders) further comprising functionally active species. A catalyst composition may typically be applied in the form of a washcoat containing supports having catalytically active species thereon. A sorbent composition may typically be applied in the form of a washcoat containing sorption active species. Catalyst and sorbent components may also be combined in a single washcoat. A washcoat is formed by preparing a slurry containing a specified solids content (e.g., about 10 to about 60% by weight) of supports in a liquid vehicle, which is then applied to a metal fiber felt or a three dimensional metal fiber felt substrate and dried and calcined to provide a coating layer. If multiple coating layers are applied, the substrate is dried and calcined after each layer is applied and/or after the number of desired multiple layers are applied.

Catalyst and/or sorbent compositions may be prepared using a binder, for example, a ZrO₂ binder derived from a suitable precursor such as zirconyl acetate or any other suitable zirconium precursor such as zirconyl nitrate. A zirconyl acetate binder provides a coating that remains homogeneous and intact after thermal aging, for example, when the catalyst is exposed to high temperatures of at least about 600° C., for example, about 800° C. and higher and high water vapor environments of about 5% or more. Other potentially suitable binders include, but are not limited to, alumina and silica. Alumina binders include aluminum oxides, aluminum hydroxides and aluminum oxyhydroxides. Aluminum salts and colloidal forms of alumina may also be used. Silica binders include various forms of SiO₂, including silicates and colloidal silica. Binder compositions may include any combination of zirconia, alumina and silica.

The present catalyst and/or sorbent functional compositions are present on/in the metal fiber felts at a loading (concentration) of, for instance, from about 0.1 g/in³ to about 8.0 g/in³ based on the metal fiber felt substrate volume; from about 0.3 g/in³ to about 7.0 g/in³; or from about 0.4 g/in³, about 0.5 g/in³, about 0.6 g/in³, about 0.7 g/in³, about 0.8 g/in³, about 0.9 g/in³ or about 1.0 g/in³ to about 1.5 g/in³, about 2.0 g/in³, about 2.5 g/in³, about 3.0 g/in³, about 3.5 g/in³, about 4.0 g/in³, about 4.5 g/in³, about 5.0 g/in³, about 5.5 g/in³, about 6.0 g/in³, about 6.5 g/in³, about 7.0 g/in³ or about 7.5 g/in³ or about 8 g/in³. This refers to dry solids weight of the catalyst coating per volume of substrate. These loading levels also pertain to catalyst and/or sorbent functional coatings applied to secluding foils.

The high void volume of the metal fiber felt allows for high loading of functional compositions. This is a particular advantage for applications that require a high loading of catalytic or adsorptive species in order to maximize functional performance. For example, the functional composition may comprise up to about 50% of the total weight (functional composition and metal felt). For example the functional composition may comprise from about 2%, about 5%, about 10%, about 15%, about 20% or about 25% to about 30%, about 40%, about 45% or about 50% of the total weight of the metal felt plus functional composition on a dry solids basis.

The present functional articles may be, for example, flow-through articles where exhaust gas flow enters the inlet end of the three dimensional metal fiber felt structure and exits the opposite outlet end after passing through the plurality of gas flow channels extending from the inlet end to the outlet end. At certain high functional composition loadings, the channel walls comprising the metal fiber felt are effectively completely filled/plugged with the functional composition, so that no flow of gases through the walls is possible except via diffusion. The present functional catalyst and/or sorbent compositions can occupy from about 5%, about 10%, about 20%, about 30%, about 40% or about 50% to about 60%, about 70%, about 80%, about 95% or about 100% of the original void volume of the metal fiber felt substrate that exists before coating with the functional composition.

Unlike a conventional ceramic or metal foil substrate where a functional composition is contacted by exhaust gas from only one side due to the presence of the impermeable substrate wall, the porous wall of the coated metal fiber felt substrate of the present invention allows contact of the functional composition with exhaust gases from both sides of the felt. This enables utilization of thicker coatings and minimizes diffusion limitations of the functional performance, particularly if less than 100% of the metal felt void volume is occupied by the functional catalytic and/or adsorptive composition.

In some embodiments, the present functional articles may be for example wall-flow articles where exhaust gas flow entering the inlet end of the three dimensional metal fiber felt structure must pass through the wall of the felt before exiting the outlet end of the article. Such a configuration is possible only if the channel walls (metal felt) have sufficient porosity to allow passage of the exhaust gases. For embodiments where the felt is comprised of cladded filaments with no additionally applied catalyst or sorbent coating, the porosity of the felt must be optimized to balance filtration efficiency and pressure drop of the article. For embodiments where the felt is comprised of cladded filaments and also additionally applied catalyst or sorbent coating, the porosity of the felt and the catalyst or sorbent loading must both be optimized to balance filtration efficiency and pressure drop of the article. In either case, the void volume of the metal fiber felt including any optional catalyst or sorbent coating can be from about 20%, about 25%, about 30%, 35%, about 40%, about 45%, about 50% or about 55% to about 60%, about 65%, about 70%, about 75%, about 80%, about 85% or about 90% of the total volume of the metal felt, on average.

A portion of the article cells may be fully or partially blocked at an inlet and/or outlet face of the article, for example about every other cell is fully or partially blocked at the inlet and/or outlet face. Such an article may provide a wall-flow article.

Among others, the functional catalyst composition applied to a three dimensional structure (e.g., metal felt monolith) comprising cladded filaments may comprise a diesel oxidation catalyst (DOC), a lean NOx trap (LNT), a three-way conversion catalyst (TWC), an ammonia oxidation catalyst (AMOx), or a selective catalytic reduction catalyst (SCR).

Among others, the functional adsorbent composition may comprise a molecular sieve such as a zeolite for adsorbing gaseous components such as hydrocarbons or ammonia or it may comprise a basic material such as an alkaline earth oxide or carbonate for adsorbing acidic gases such as NO₂ and SO₂ and SO₃.

The support material on which the catalytically active metal is deposited for example comprises a refractory metal oxide, which exhibits chemical and physical stability at high temperatures, such as the temperatures associated with gasoline or diesel engine exhaust. Exemplary metal oxides include alumina, silica, zirconia, titania, ceria, praseodymia, tin oxide and the like, as well as physical mixtures or chemical combinations thereof, including atomically-doped combinations and including high surface area or activated compounds such as activated alumina.

Included are combinations of metal oxides such as silica-alumina, ceria-zirconia, praseodymia-ceria, alumina-zirconia, alumina-ceria-zirconia, lanthana-alumina, lanthana-zirconia-alumina, baria-alumina, baria-lanthana-alumina, baria-lanthana-neodymia-alumina and alumina-ceria. Exemplary aluminas include large pore boehmite, gamma-alumina and delta/theta alumina. Useful commercial aluminas used as starting materials in exemplary processes include activated aluminas, such as high bulk density gamma-alumina, low or medium bulk density large pore gamma-alumina and low bulk density large pore boehmite and gamma-alumina.

High surface area metal oxide supports, such as alumina support materials, also referred to as “gamma alumina” or “activated alumina,” typically exhibit a BET surface area in excess of 60 m²/g, often up to about 200 m²/g or higher. An exemplary refractory metal oxide comprises high surface area γ-alumina having a specific surface area of about 50 to about 300 m²/g. Such activated alumina is usually a mixture of the gamma and delta phases of alumina, but may also contain substantial amounts of eta, kappa and theta alumina phases. “BET surface area” has its usual meaning of referring to the Brunauer, Emmett, Teller method for determining surface area by N₂ adsorption. Desirably, the active alumina has a specific surface area of about 60 to about 350 m²/g, for example from about 90 to about 250 m²/g.

In certain embodiments, metal oxide supports useful in the catalyst compositions disclosed herein are doped alumina materials, such as Si-doped alumina materials (including, but not limited to 1-10% SiO₂—Al₂O₃), doped titania materials, such as Si-doped titania materials (including, but not limited to 1-10% SiO₂—TiO₂) or doped zirconia materials, such as Si-doped ZrO₂ (including, but not limited to 5-30% SiO₂—ZrO₂).

Advantageously, a refractory metal oxide may be doped with one or more additional basic metal oxide materials such as lanthanum oxide, barium oxide, strontium oxide, calcium oxide, magnesium oxide or combinations thereof. The metal oxide dopant is typically present in an amount of about 1 to about 20% by weight, based on the weight of the catalyst composition. The dopant oxide materials may serve to improve the high temperature stability of the refractory metal oxide support or function as an adsorbent for acidic gases such as NO₂, SO₂ or SO₃.

The dopant metal oxides can be introduced using an incipient wetness impregnation technique or by addition of colloidal mixed oxide particles. Preferred doped metal oxides include baria-alumina, baria-zirconia, baria-titania, baria-zirconia-alumina, lanthana-zirconia and the like.

Thus the refractory metal oxides or refractory mixed metal oxides in the catalyst compositions are typically selected from the group consisting of alumina, zirconia, silica, titania, ceria, for example bulk ceria, manganese oxide, zirconia-alumina, ceria-zirconia, ceria-alumina, lanthana-alumina, baria-alumina, silica, silica-alumina and combinations thereof. Further doping with basic metal oxides provides additional useful refractory oxide supports including but not limited to baria-alumina, baria-zirconia, baria-titania, baria-zirconia-alumina, lanthana-zirconia and the like.

The catalyst composition may comprise any of the above-named refractory metal oxides and in any amount. For example refractory metal oxides in the catalyst composition may comprise at least about 15, at least about 20, at least about 25, at least about 30 or at least about 35 wt % (weight percent) alumina where the wt % is based on the total dry weight of the catalyst composition. The catalyst composition may for example comprise from about 10 to about 99 wt % alumina, from about 15 to about 95 wt % alumina or from about 20 to about 85 wt % alumina.

The catalyst composition comprises for example from about 15 wt %, about 20 wt %, about 25 wt %, about 30 wt % or about 35 wt % to about 50 wt %, about 55 wt %, about 60 wt % about 65 wt % or about 70 wt % alumina based on the weight of the catalytic composition.

Advantageously, the catalyst composition may comprise ceria, alumina and zirconia or doped compositions thereof.

The catalyst composition coated onto the metal fiber felt substrate may comprise a noble metal present from about 0.1 wt %, about 0.5 wt %, about 1.0 wt %, about 1.5 wt % or about 2.0 wt % to about 3 wt %, about 5 wt %, about 7 wt %, about 9 wt %, about 10 wt %, about 12 wt %, about 15 wt %, about 16 wt %, about 17 wt %, about 18 wt %, about 19 wt % or about 20 wt %, based on the weight of the dry composition.

The noble metal of the catalyst composition is, for example, present from about 5 g/ft³, 10 g/ft³, about 15 g/ft³, about 20 g/ft³, about 40 g/ft³ or about 50 g/ft³ to about 70 g/ft³, about 90 g/ft³, about 100 g/ft³, about 120 g/ft³, about 130 g/ft³, about 140 g/ft³, about 150 g/ft³, about 160 g/ft³, about 170 g/ft³, about 180 g/ft³, about 190 g/ft³, about 200 g/ft³, about 210 g/ft³, about 220 g/ft³, about 230 g/ft³, about 240 g/ft³ or about 250 g/ft³, based on the volume of the three dimensional structure comprising the metal fiber felt.

The catalyst composition in addition to the refractory metal oxide support and catalytically active metal may further comprise any one or combinations of the oxides of lanthanum, barium, praseodymium, neodymium, samarium, strontium, calcium, magnesium, niobium, hafnium, gadolinium, terbium, dysprosium, erbium, ytterbium, manganese, iron, chromium, tin, zinc, nickel, cobalt or copper.

Oxidation, LNT and three-way catalysts advantageously comprise a platinum group metal (PGM) dispersed on a refractory metal oxide support.

Functional catalyst and/or sorbent compositions may (also) comprise a sorbent useful for adsorbing hydrocarbons (HC) from the engine exhaust during startup of the vehicle when the catalyst is cold and unable to oxidize the hydrocarbons to CO₂ (cold start). When the temperature of the exhaust increases to the point when the platinum group metal in the catalyst becomes active, hydrocarbon is released from the sorbent and is subsequently oxidized to CO₂. Any known hydrocarbon storage material can be used, e.g., a micro-porous material such as a zeolite or zeolite-like material. In a preferred embodiment, the hydrocarbon storage material is a zeolite. The zeolite can be a natural or synthetic zeolite such as faujasite, chabazite, clinoptilolite, mordenite, silicalite, zeolite X, zeolite Y, ultrastable zeolite Y, ZSM-5 zeolite, offretite or a beta zeolite. Preferred zeolite adsorbent materials have a high silica to alumina ratio. The zeolites may have a silica/alumina molar ratio of from at least about 5:1, preferably at least about 50:1, with useful ranges of from about 5:1 to 1000:1, 50:1 to 500:1, as well as about 25:1 to 300:1. Preferred zeolites include ZSM, Y and beta zeolites. A particularly preferred adsorbent may comprises a beta zeolite of the type disclosed in U.S. Pat. No. 6,171,556 to Burk et al., incorporated herein by reference in its entirety.

SCR catalysts include but are not limited to base metal (e.g., copper and/or iron) ion-exchanged molecular sieves (e.g., Cu—Y or Fe-beta) or vanadia-based compositions such as for example V₂O₅/WO₃/TiO₂/SiO₂. Base metal ion-exchanged zeolites are described, for example, in U.S. Pat. No. 7,998,423 to Boorse et al., which is incorporated herein by reference. One exemplary SCR catalyst is CuCHA, for example copper-SSZ-13. Molecular sieves exhibiting structures similar to chabazite such as SAPO are also found effective. Thus, CuSAPO, for example copper-SAPO-34 is also suitable. Further suitable SCR compositions are also disclosed, for example, in U.S. Pat. No. 9,017,626 to Tang et al., U.S. Pat. No. 9,242,238 to Mohanan et al., and U.S. Pat. No. 9,352,307 to Stiebels et al., which are incorporated herein by reference. For example, such SCR compositions include compositions comprising a vanadia/titania catalyst and a Cu-zeolite or comprising a mixture of a Cu-containing molecular sieve and a Fe-containing molecular sieve.

Molecular sieves refer to materials having an extensive three-dimensional network of oxygen ions containing generally tetrahedral type sites and having a pore distribution of relatively uniform pore size. A zeolite is a specific example of a molecular sieve, further including silicon and aluminum. Reference to a “non-zeolite-support” or “non-zeolitic support” in a catalyst layer refers to a material that is not a zeolite and that receives precious metals, stabilizers, promoters, binders and the like through association, dispersion, impregnation or other suitable methods. Examples of such non-zeolitic supports include, but are not limited to, high surface area refractory metal oxides. High surface area refractory metal oxide supports can comprise an activated compound selected from the group consisting of alumina, zirconia, silica, titania, ceria, lanthana, baria and combinations thereof.

Useful molecular sieves incorporated into SCR catalysts for instance have 8-ring pore openings and double-six ring secondary building units, for example, those having the following structure types: AEI, AFT, AFX, CHA, EAB, ERI, KFI, LEV, SAS, SAT or SAV. Included are any and all isotopic framework materials such as SAPO, AlPO and MeAPO materials having the same structure type.

Aluminosilicate zeolite structures do not include phosphorus or other metals isomorphically substituted in the framework. That is, “aluminosilicate zeolite” excludes aluminophosphate materials such as SAPO, AlPO and MeAPO materials, while the broader term “zeolite” includes aluminosilicates and aluminophosphates.

The 8-ring small pore molecular sieves include aluminosilicates, borosilicates, gallosilicates, MeAPSOs and MeAPOs. These include, but are not limited to SSZ-13, SSZ-62, natural chabazite, zeolite K-G, Linde D, Linde R, LZ-218, LZ-235, LZ-236, ZK-14, SAPO-34, SAPO-44, SAPO-47, ZYT-6, CuSAPO-34, CuSAPO-44 and CuSAPO-47. In specific embodiments, the 8-ring small pore molecular sieve will have an aluminosilicate composition, such as SSZ-13 and SSZ-62.

In one or more embodiments, the 8-ring small pore molecular sieve has the CHA crystal structure and is selected from the group is consisting of aluminosilicate zeolite having the CHA crystal structure, SAPO, AlPO and MeAPO. In particular, the 8-ring small pore molecular sieve having the CHA crystal structure is an aluminosilicate zeolite having the CHA crystal structure. In a specific embodiment, the 8-ring small pore molecular sieve having the CHA crystal structure will have an aluminosilicate composition, such as SSZ-13 and SSZ-62. Copper- and iron-containing chabazite are termed CuCHA and FeCHA.

Molecular sieves can be zeolitic (zeolites) or may be non-zeolitic. Both zeolitic and non-zeolitic molecular sieves can have the chabazite crystal structure, which is also referred to as the CHA structure by the International Zeolite Association. Zeolitic chabazite includes a naturally occurring tectosilicate mineral of a zeolite group with approximate formula (Ca,Na₂,K₂,Mg)Al₂Si₄O_{12·6}H₂O (i.e., hydrated calcium aluminum silicate). Three synthetic forms of zeolitic chabazite are described in “Zeolite Molecular Sieves,” by D. W. Breck, published in 1973 by John Wiley & Sons, which is hereby incorporated by reference. The three synthetic forms reported by Breck are Zeolite K-G, described in J. Chem. Soc., p. 2822 (1956), Barrer et. Al.; Zeolite D, described in British Patent No. 868,846 (1961); and Zeolite R, described in U.S. Pat. No. 3,030,181 to Milton, which are hereby incorporated by reference. Synthesis of another synthetic form of zeolitic chabazite, SSZ-13, is described in U.S. Pat. No. 4,544,538. Synthesis of a synthetic form of a non-zeolitic molecular sieve having the chabazite crystal structure, silicoaluminophosphate 34 (SAPO-34), is described in U.S. Pat. No. 4,440,871 to Lok et al. and U.S. Pat. No. 7,264,789 to Van Den et al., which are incorporated herein by reference. A method of making yet another synthetic non-zeolitic molecular sieve having chabazite structure, SAPO-44, is described, for instance, in U.S. Pat. No. 6,162,415 to Liu et al., which is incorporated herein by reference. Molecular sieves having a CHA structure may be prepared, for instance, according to methods disclosed in U.S. Pat. No. 4,544,538 to Zones and U.S. Pat. No. 6,709,644 to Zones et al., which are incorporated herein by reference. Suitable zeolites also include Beta zeolite and Y zeolite.

The present molecular sieves are for example copper- or iron-containing. The copper or iron resides in the ion-exchange sites of the molecular sieves and may also be associated with the molecular sieves but not “in” the pores. For example, upon calcination, non-exchanged copper salt decomposes to CuO, also referred to herein as “free copper” or “soluble copper.” The free base metal may be advantageous as disclosed in U.S. Pat. No. 8,404,203 to Bull et al., which is incorporated herein by reference. The amount of free base metal may be less than, equal to or greater than the amount of ion-exchanged base metal. All base metal associated with a molecular sieve is part of any base metal-containing molecular sieve.

LNT catalysts are taught, for instance, in U.S. Pat. No. 8,475,752 to Wan and U.S. Pat. No. 9,321,009 to Wan et al., which are incorporated herein by reference. LNT catalysts are believed to operate via promoting storage of NOx during a lean period of operation where the air to fuel ratio (λ) is greater than 1 (i.e. λ>1.0) and catalyze reduction of stored NOx to N₂ during a rich period where the air to fuel ratio (λ) is less than 1 (i.e. λ<1.0). Some LNT catalysts will release NOx above a specific temperature. This temperature is dependent upon the composition of the LNT coating.

The LNT catalyst compositions typically comprise a NOx sorbent and a platinum group metal component dispersed on a refractory metal oxide support. The LNT catalyst composition may optionally contain other components such as oxygen storage components.

A suitable NOx sorbent comprises a basic oxygenated compound of an alkaline earth element selected from magnesium, calcium, strontium, barium and mixtures thereof and/or an oxygenated compound of a rare earth component such as cerium (ceria component). The rare earth compound may further contain one or more of lanthanum, neodymium or praseodymium.

The present functional metal fiber felts comprising noble metal cladded filaments may further comprise a sorbent useful for trapping and releasing for example NOx or sulfur compounds. Sorbents include but are not limited to materials such as alkaline earth metal oxides, alkaline earth metal carbonates, rare earth oxides and molecular sieves. In addition the present functional fiber felts may also comprise a sorbent useful for trapping and releasing hydrocarbons (HC). Sorbents include, but are not limited to materials such as molecular sieves and zeolites.

AMOx catalysts are taught, for instance, in U.S. Pat. Appl. Pub. No. 2011/0271664 to Boorse et al., which is incorporated herein by reference. An ammonia oxidation (AMOx) catalyst may be a supported precious metal component which is effective to remove ammonia from an exhaust gas stream. The precious metal may include ruthenium, rhodium, iridium, palladium, platinum, silver or gold. The precious metal component may also include physical mixtures or chemical or atomically-doped combinations of precious metals. The precious metal component for instance includes platinum. Platinum may be present in an amount of from about 0.008% to about 2 wt % based on the total weight of the AMOx catalyst.

The precious metal component of an AMOX catalyst is typically deposited on a high surface area refractory metal oxide support. Examples of suitable high surface area refractory metal oxides include alumina, silica, titania, ceria and zirconia, as well as physical mixtures, chemical combinations and/or atomically-doped combinations thereof. In specific embodiments, the refractory metal oxide may contain a mixed oxide such as silica-alumina, amorphous or crystalline aluminosilicates, alumina-zirconia, alumina-lanthana, alumina-chromia, alumina-baria, alumina-ceria and the like. An exemplary refractory metal oxide comprises high surface area γ-alumina having a specific surface area of about 50 to about 300 m²/g.

The AMOx catalyst may include a zeolitic or non-zeolitic molecular sieve for example selected from those of the CHA, FAU, BEA, MFI and MOR types. A molecular sieve may be physically mixed with an oxide-supported platinum component. In an alternative embodiment, platinum may be distributed on the external surface or in the channels, cavities or cages of the molecular sieve.

TWC catalyst compositions are disclosed, for instance, in U.S. Pat. No. 4,171,288 to Keith et al. and U.S. Pat. No. 8,815,189 to Arnold et al., which are incorporated herein by reference. TWC catalysts typically comprise for example one or more platinum group metals disposed on a high surface area, refractory metal oxide support, e.g., a high surface area alumina coating. The refractory metal oxide supports may be stabilized against thermal degradation by materials such as zirconia, titania, alkaline earth metal oxides such as baria, calcia or strontia or, most usually, rare earth metal oxides, for example, ceria, lanthana and mixtures of two or more rare earth metal oxides. TWC catalysts can also be formulated to include an oxygen storage component.

The articles of this invention may comprise one or more catalyst compositions selected from a diesel oxidation catalyst (DOC), a lean NOx trap (LNT), a three-way catalyst (TWC), an ammonia oxidation catalyst (AMOx) and a selective catalytic reduction (SCR) catalyst.

In certain embodiments, the articles of the present invention may comprise three dimensional structures (e.g. metal felt monoliths) comprising only the cladded filaments of the present invention without application of an additional catalyst or adsorbent coating. Such an article, for example, could be a DOC, a TWC or an AMOx catalyst article. An exemplary DOC article could comprise filaments clad with Pt or a Pt/Pd alloy. An exemplary TWC article could comprise filaments clad with Pd, filaments clad with Rh, filaments clad with a Pd/Rh alloy, a mixture of filaments where some are clad with Pd and others are clad with Rh or a mixture of filaments where some are clad with Pd, some are clad with Rh and some are clad with Pt. An exemplary AMOx article could comprise filaments clad with Pt.

In other embodiments, the articles of the present invention may comprise three dimensional structures (e.g. metal felt monoliths) comprising the cladded filaments of the present invention with application of an additional catalyst or adsorbent coating. Such an article, for example, could be a DOC, a TWC, a LNT, a SCR or an AMOx catalyst article. An exemplary DOC article could comprise filaments clad with Pt or a Pt/Pd alloy and further comprising an adsorbent coating such as a Beta zeolite. An exemplary TWC article could comprise filaments clad with Pd and further comprising a catalytic coating comprising Rh dispersed on ceria or alumina. An exemplary LNT article could comprise filaments clad with Pt and further comprising an adsorbent coating comprising alkaline earth oxide or carbonate materials and ceria. An exemplary SCR article could comprise filaments clad with Pt and further comprising an adsorbent coating comprising Cu-exchanged zeolite. An exemplary AMOx article could comprise filaments clad with Pt and further comprising an adsorbent coating comprising Cu-exchanged zeolite.

These examples for possible functional catalytic articles of the present invention are meant to be exemplary and not limiting. Numerous other combinations of cladded filaments with or without additionally applied catalyst or sorbent coating are possible.

In some embodiments, the catalyst composition is substantially free of noble metals, e.g., substantially free of platinum group metals. “Substantially free” means for instance “little or no”, for instance, means “no intentionally added” and having only trace and/or inadvertent amounts. For instance, it means less than 2 wt. % (weight %), less than 1.5 wt. %, less than 1.0 wt. %, less than 0.5 wt. %, 0.25 wt. % or less than 0.01 wt. %, based on the weight of the indicated total composition.

The metal fiber felt substrates of the present invention comprising noble metal cladded fibers or filaments may advantageously further comprise zoned coatings, that is, containing a catalyst and/or sorbent coating layer with a certain function at the inlet end of the three dimensional fiber felt structure and a different catalyst coating layer with a different function at the outlet end. Zoned coating layers may overlap (overlay). Any one coating layer may extend from the inlet end towards the outlet end (or from the outlet end to the inlet end) about 10%, about 20%, about 30%, about 40%, about 50%, about 60%, about 70%, about 80% or about 90% of the axial length of the metal felt substrate. Any one coating layer may extend the entire axial length of the substrate.

A catalyst and/or sorbent coating layer may entirely overlay or partially overlay another catalyst and/or sorbent coating layer. Alternatively, two different coating layers may extend from opposite ends of the substrate and not overlay. Two different coating layers may be adjacent.

The final coating composition comprises one or more coating layers. Thus, a final coating composition may have more than one function as each applied coating layer may have a same or different function.

### Exhaust Gas Treatment System

Also disclosed is an exhaust gas treatment system comprising a present functional article. A typical system of the present invention contains more than one article. These articles may include, for instance, a reductant injector, a diesel oxidation catalyst (DOC), a lean NOx trap (LNT), a three-way catalyst (TWC), a catalyzed soot filter (CSF), a selective catalytic reduction catalyst (SCR) or an ammonia oxidation catalyst (AMOx). The articles of the system of the present invention may comprise three dimensional structures (e.g. metal felt monoliths) comprising the cladded filaments of the present invention without application of an additional catalyst or adsorbent coating, three dimensional structures (e.g. metal felt monoliths) comprising the cladded filaments of the present invention with application of an additional catalyst or adsorbent coating or catalyst or adsorbent coatings applied to standard ceramic or metallic substrates known in the art. The system of the present invention may comprise any combination of coated or uncoated articles.

One embodiment for a system of the present invention may include (from upstream to downstream) a DOC article comprising a metal felt substrate further comprising cladded filaments, a CSF article coated on a ceramic wall-flow filter known in the art, a reductant injector, an SCR article coated on a ceramic flow through monolith known in the art and an AMOx article coated on a ceramic flow through monolith known in the art. Another embodiment of the present invention may include a DOC article comprising a metal felt substrate further comprising cladded filaments and a zeolite sorbent coating applied thereon, a CSF article coated on a ceramic wall-flow filter, a reductant injector, an SCR article coated on a ceramic flow through monolith and an AMOx article coated on a ceramic flow through monolith. Yet another embodiment of the present invention may include a DOC article comprising a metal felt substrate further comprising cladded filaments and a zeolite sorbent coating applied thereon, a CSF article coated on a ceramic wall-flow filter, a reductant injector, an SCR article coated on a ceramic flow through monolith and an AMOx article comprising a metal felt substrate further comprising cladded filaments and a zeolite sorbent coating applied thereon. Yet another exemplary embodiment of the present invention may include an LNT article comprising a metal felt substrate further comprising cladded filaments and an alkaline earth sorbent coating applied thereon, a CSF article coated on a ceramic wall-flow filter, a reductant injector, an SCR article coated on a ceramic flow through monolith and an AMOx article comprising a metal felt substrate further comprising cladded filaments and a zeolite sorbent coating applied thereon. Systems with fewer articles (e.g. without an AMOX catalytic article) are also possible.

Another embodiment may include a TWC article comprising a metal felt substrate further comprising cladded filaments wherein the article is placed in an underfloor position. Another embodiment may include a TWC article comprising a metal felt substrate further comprising cladded filaments wherein the article is placed in a close coupled position. Yet another embodiment may include a TWC article comprising a metal felt substrate further comprising cladded filaments wherein the article is placed in a close coupled position while an additional TWC article coated on a standard ceramic flow through monolith is placed in an underfloor position. Yet another embodiment may include a TWC article comprising a metal felt substrate further comprising cladded filaments wherein the metal felt substrate is configured such that exhaust gas entering the inlet of the article must pass through the wall of the felt before exiting the outlet of the article.

These embodiments for a system comprising a present functional article are meant to be exemplary and not limiting. Numerous other combinations of articles that utilize the cladded filaments of the present invention are possible.

A soot filter may be an uncatalyzed or a catalyzed (CSF) wall-flow filter. Also included may be an SCR catalyst coated onto a soot filter.

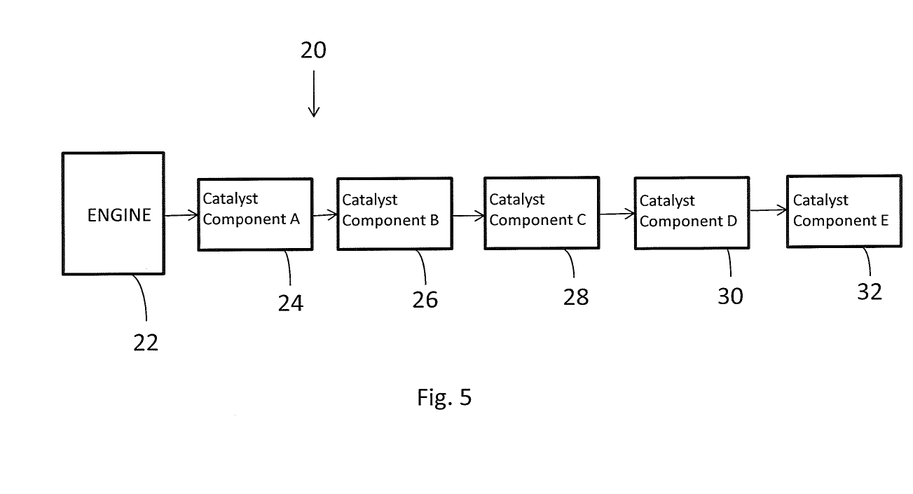

One exemplary emission treatment system is illustrated in FIG. 5, which depicts a schematic representation of an emission treatment system 20. As shown, the emission treatment system can include a plurality of catalyst components in series downstream of an engine 22, such as a lean burn engine. At least one of the catalyst components will comprise the metal felt of the invention as set forth herein. The catalyst composition of the invention could be combined with numerous additional catalyst materials and could be placed at various positions in comparison to the additional catalyst materials. FIG. 5 illustrates five catalyst components, 24, 26, 28, 30, 32 in series; however, the total number of catalyst components can vary and five components is merely one example.

Table 1 below presents various system configurations of an emission treatment system of the invention. The reference to Components A-E in the table can be cross-referenced with the same designations in FIG. 5. It is noted that each component is connected to the next component via exhaust conduits such that the engine is upstream of component A, which is upstream of component B, which is upstream of component C, which is upstream of component D, which is upstream of component E (when present). As recognized by one skilled in the art, in the configurations listed in Table 1, any one or more of components A, B, C, D, or E can be disposed on a particulate filter such as a wall flow filter. For example, in some embodiments, an SCR catalyst on a filter (SCRoF) can be employed, e.g., in place of the SCR components in Table 1.

TABLE 1

| Component | Component | | Component | Component |
|---|---|---|---|---|
| A | B | Component C | D | E |
| DOC | SCRoF | Optional | — | — |
| | | AMOx | | |
| DOC | Soot Filter | SCR | Optional | — |
| | | | AMOx | |
| DOC | CSF | SCR | Optional | — |
| | | | AMOx | |
| TWC | CSF | — | — | — |
| TWC | TWC | CSF | — | — |
| TWC | LNT-TWC | CSF | — | — |
| LNT-TWC | TWC | CSF | — | — |
| TWC | LNT-TWC | LNT | — | — |
| LNT-TWC | TWC | LNT | — | — |
| LNT | CSF | Optional | — | — |
| | | AMOx | | |
| LNT | SCR | Optional | — | — |
| | | AMOx | | |
| LNT | SCRoF | Optional | — | — |
| | | AMOx | | |
| LNT | CSF | SCR | Optional | — |
| | | | AMOx | |

Present catalytic articles are suitable for treatment of exhaust gas streams of internal combustion engines, for example gasoline and diesel engines. The articles are also suitable for treatment of emissions from stationary industrial processes (e.g. power plants) and for removal or noxious or toxic substances from ambient air (for example, but not limited to indoor air) or liquid streams (for example, but not limited to industrial and/or municipal waste waters). The articles are also suitable for use in chemical manufacturing processes requiring the use of a catalyst.

Examples of the use of the present articles for removal or noxious or toxic substances from liquid streams or for catalysis in chemical manufacturing processes include but are not limited to the purification of sulfides from industrial and/or municipal waste water via selective oxidation to elemental sulfur, oxidation of hydrocarbon contaminants and/or other undesirable organic compounds in industrial waste and/or municipal waste waters, potable water denitrification via selective catalytic reduction of dissolved nitrates and nitrites, selective catalytic hydrogenation of vegetable oils and selective catalytic hydrogenation of unsaturated hydrocarbons (including but not limited to acetylenic) or other undesirable unsaturated organic compounds.

The present disclosure also includes, without limitation, the following further embodiments:

### Further Embodiment 1

A metal fiber felt comprising catalytic metal fibers which comprise a core comprising a first metal selected from the group consisting of aluminum, aluminum alloy, copper, copper alloy, stainless steel, nickel, nickel/chromium alloy, iron/chromium alloy and noble metals and a shell comprising a catalytic metal selected from the group consisting of noble metals.

### Further Embodiment 2

A metal felt according to any preceding embodiment, wherein the diameter of the metal fibers is about 1 μm, about 2 μm, about 3 μm, about 4 μm, about 5 μm, about 6 μm, about 7 μm, about 8 μm, about 9 μm or about 10 μm, on average; or about 10 μm, about 20 μm, about 30 μm, about 40 μm, about 50 μm, about 60 μm, about 70 μm, about 80 μm, about 90 μm, about 100 μm, about 110 μm, about 120 μm, about 130 μm, about 140 μm, or about 150 μm, on average.

### Further Embodiment 3

A metal felt according to any preceding embodiment, wherein the shell is about 1 nm, about 2 nm, about 3 nm, about 4 nm, about 5 nm, about 6 nm, about 7 nm, about 8 nm, about 9 nm or about 10 nm, thick, on average; or wherein the shell is about 10 nm, about 20 nm, about 30 nm, about 40 nm, about 50 nm, about 60 nm, about 70 nm, about 80 nm, about 90 nm, or about 100 nm thick, on average.

### Further Embodiment 4

A metal felt according to any preceding embodiment, wherein the shell comprises a metal component selected from the group consisting of Pt, Pd, Rh, Au, Ag, Ru, Ir and alloys thereof.

### Further Embodiment 5

A metal felt according to any preceding embodiment, wherein the shell further comprises a base metal; for example a base metal selected from the group consisting of Cu, Fe, Ni, Cr, Mo, Mn, Zn, Co, W and Al.

### Further Embodiment 6

A metal felt according to any preceding embodiment, wherein the metal felt comprises catalytic fibers having different shells; for example, the metal felt comprises first fibers comprising a shell comprising a first noble metal and second fibers comprising a shell comprising a second noble metal; for example, the metal felt comprises first fibers having a shell comprising Pd and second fibers having a shell comprising Rh.

### Further Embodiment 7

A metal felt according to any preceding embodiment, wherein the metal felt comprises catalytic fibers having different shells, where the different catalytic fibers are essentially uniformly distributed throughout the felt or, alternatively, where the different catalytic fibers are segregated in different regions of the felt.

### Further Embodiment 8

A metal felt according to any preceding embodiment, wherein the shell comprises a Pt, Pd or Rh component or mixtures thereof.

### Further Embodiment 9

A metal felt according to any preceding embodiment, wherein the shell comprises more than one layer.

### Further Embodiment 10

A metal felt according to any preceding embodiment, wherein the shell comprises at least two different layers; for example a layer comprising a noble metal and a layer comprising a noble metal and a base metal.

### Further Embodiment 11

A metal felt according to any preceding embodiment, wherein the metal felt is woven.

### Further Embodiment 12

A metal felt according to any preceding embodiment, wherein the metal felt is non-woven.

### Further Embodiment 13

A metal felt according to any preceding embodiment, wherein the metal felt is flat.

### Further Embodiment 14

A metal felt according to any preceding embodiment, wherein the metal felt is corrugated.

### Further Embodiment 15

A metal felt according to any preceding embodiment, further comprising reinforcing metal fibers which comprise a metal selected from the group consisting of aluminum, aluminum alloy, copper, copper alloy, stainless steel, nickel, nickel/chromium alloy and iron/chromium alloy.

### Further Embodiment 16

A metal felt according to any preceding embodiment, further comprising reinforcing metal fibers which comprise a FeCr alloy.

### Further Embodiment 17

A metal felt according to any preceding embodiment, wherein the metal felt has a void volume of about 20%, about 30%, 35%, about 40%, about 45%, about 50% or about 55% to about 60%, about 65%, about 70%, about 75%, about 80%, about 85%, about 90% or about 95%, based on the total volume of the metal felt.

### Further Embodiment 18

A metal felt according to any preceding embodiment, wherein the metal fiber felt is about 50 μm, about 75 μm, 100 μm, about 125 μm, about 150 μm, about 175 μm, about 200 μm, about 225 μm, about 250 μm, about 275 μm, about 300 μm, about 325 μm, about 350 μm, about 375 μm, about 400 μm, about 425 μm, about 450 μm, about 475 μm or about 500 μm thick on average; or, alternatively, the metal fiber felt is for instance from about 200 μm to about 1 inch (25,400 μm), for example from about 300 μm to about 20,000 μm, from about 400 μm to about 18,000 μm, from about 500 μm to about 15,000 μm or from about 600 μm to about 12,000 μm thick on average.

### Further Embodiment 19

A metal felt according to any preceding embodiment, further comprising a catalytic and/or sorbent coating; for example at a loading of from about 0.1 g/in³ to about 8.0 g/in³; for example where the catalytic coating comprises one or more of DOC, LNT, SCR, AMOx or TWC compositions; for example where the sorbent coating comprises one or more of a HC or NOx sorbent composition.

### Further Embodiment 20

A metal felt according to any preceding embodiment, wherein the metal fiber felt contains no further added catalytic coating or sorbent coating.

### Further Embodiment 21

A catalyst article comprising a metal fiber felt, the metal felt comprising catalytic metal fibers which comprise a core comprising a first metal selected from the group consisting of aluminum, aluminum alloy, copper, copper alloy, stainless steel, nickel, nickel/chromium alloy, iron/chromium alloy and noble metals and a shell comprising a catalytic metal selected from the group consisting of noble metals.

### Further Embodiment 22

An article according to any preceding embodiment, wherein the diameter of the metal fibers is about 1 μm, about 2 μm, about 3 μm, about 4 μm, about 5 μm, about 6 μm, about 7 μm, about 8 μm, about 9 μm, or about 10 μm, on average; or about 10 μm, about 20 μm, about 30 μm, about 40 μm, about 50 μm, about 60 μm, about 70 μm, about 80 μm, about 90 μm, about 100 μm, about 110 μm, about 120 μm, about 130 μm, about 140 μm or about 150 μm, on average.

### Further Embodiment 23

An article according to any preceding embodiment, wherein the shell is about 1 nm, about 2 nm, about 3 nm, about 4 nm, about 5 nm, about 6 nm, about 7 nm, about 8 nm, about 9 nm, or about 10 nm, thick, on average; or where the shell is about 10 nm, about 20 nm, about 30 nm, about 40 nm, about 50 nm, about 60 nm, about 70 nm, about 80 nm, about 90 nm, or about 100 nm thick, on average.

### Further Embodiment 24

An article according to any preceding embodiment, wherein the shell comprises a metal component selected from the group consisting of Pt, Pd, Rh, Au, Ag, Ru, 1r and alloys thereof.

### Further Embodiment 25

An article according to any preceding embodiment, wherein the shell further comprises a base metal; for example a base metal selected from the group consisting of Cu, Fe, Ni, Cr, Mo, Mn, Zn, Co, W and Al.

### Further Embodiment 26

An article according to any preceding embodiment, wherein the metal felt comprises catalytic fibers having different shells; for example, the metal felt comprises first fibers comprising a shell comprising a first noble metal and second fibers comprising a shell comprising a second noble metal; for example, the metal felt comprises first fibers having a shell comprising Pd and second fibers having a shell comprising Rh.

### Further Embodiment 27

An article according to any preceding embodiment, wherein the metal felt comprises catalytic fibers having different shells, where the different catalytic fibers are essentially uniformly distributed throughout the felt or, alternatively, where the different catalytic fibers are segregated in different regions of the felt.

### Further Embodiment 28

An article according to any preceding embodiment, wherein the shell comprises a Pt, Pd or Rh component or mixtures thereof.

### Further Embodiment 29

An article according to any preceding embodiment, wherein the shell comprises more than one layer.

### Further Embodiment 30

An article according to any preceding embodiment, wherein the shell comprises at least two different layers; for example a layer comprising a noble metal and a layer comprising a noble metal and a base metal.

### Further Embodiment 31

An article according to any preceding embodiment, wherein the metal felt is woven or non-woven.

### Further Embodiment 32

An article according to any preceding embodiment, wherein the metal felt is flat or corrugated.

### Further Embodiment 33

An article according to any preceding embodiment, wherein the metal felt further comprises reinforcing metal fibers which comprise one or more metals selected from the group consisting of aluminum, aluminum alloy, copper, copper alloy, stainless steel, nickel, nickel/chromium alloy and iron/chromium alloy.

### Further Embodiment 34

An article according to any preceding embodiment, wherein the metal felt further comprises reinforcing metal fibers which comprise a FeCr alloy.

### Further Embodiment 35

An article according to any preceding embodiment, comprising a three dimensional matrix comprising a plurality of metal fiber felt layers.

### Further Embodiment 36

An article according to any preceding embodiment, comprising both corrugated layers of the metal felt and flat layers of the metal felt.

### Further Embodiment 37

An article according to any preceding embodiment, comprising corrugated layers of the metal felt and flat layers of a metal foil or corrugated layers of a metal foil and flat layers of the metal felt.

### Further Embodiment 38

An article according to any preceding embodiment, wherein the metal foil contains a catalytic and/or sorbent coating.

### Further Embodiment 39

An article according to any preceding embodiment, comprising a jacket having the three dimensional matrix in the interior thereof.

### Further Embodiment 40

An article according to any preceding embodiment, wherein the metal felt has a void volume of about 20%, about 30%, 35%, about 40%, about 45%, about 50%, about 55% to about 60%, about 65%, about 70%, about 75%, about 80%, about 85%, about 90% or about 95%, based on the total volume of the metal felt.

### Further Embodiment 41

An article according to any preceding embodiment, wherein the metal fiber felt is about 50 μm, about 75 μm, 100 μm, about 125 μm, about 150 μm, about 175 μm, about 200 μm, about 225 μm, about 250 μm, about 275 μm, about 300 μm, about 325 μm, about 350 μm, about 375 μm, about 400 μm, about 425 μm, about 450 μm, about 475 μm or about 500 μm thick on average; or, alternatively, the metal fiber felt is for instance from about 200 μm to about 1 inch (25,400 μm), for example from about 300 μm to about 20,000 μm, from about 400 μm to about 18,000 μm, from about 500 μm to about 15,000 μm or from about 600 μm to about 12,000 μm thick on average.

### Further Embodiment 42

An article according to any preceding embodiment, having a cell density of from about 60 cells per square inch (cpsi) to about 500 cpsi or up to about 900 cpsi, for example from about 200 to about 400 cpsi; for example, where a portion of the cells are fully or partially blocked at an inlet and/or outlet face of the article, for example where about every other cell is fully or partially blocked at the inlet and/or outlet face.

### Further Embodiment 43

An article according to any preceding embodiment, wherein the metal fiber felt further comprises a catalytic and/or sorbent coating; for example at a loading of from about 0.1 g/in³ to about 8.0 g/in³; for example where the catalytic coating comprises one or more of DOC, LNT, SCR, AMOx or TWC compositions; for example where the sorbent coating comprises one or more of a HC or a NOx sorbent composition; for example downstream and in fluid communication with an internal combustion engine.

### Further Embodiment 44

An article according to any preceding embodiment, wherein the metal fiber felt contains no further added catalytic coating or sorbent coating; for example downstream and in fluid communication with an internal combustion engine.

### Further Embodiment 45

A catalyst article comprising catalytic fibers according to any preceding embodiment, wherein the fibers are not arranged in a metal fiber felt.

### Further Embodiment 46

A catalyst article according to any preceding embodiment, wherein the fibers are intertwined in a non-woven array.

### Further Embodiment 47

A catalyst article according to any preceding embodiment, wherein the article is a flow-through article or a wall-flow article; for example where the wall-flow article contains a functional composition or where it does not contain a functional composition.

### Further Embodiment 48

A catalyst article according to any preceding embodiment, comprising a heating coil or heating element associated therewith.

### Further Embodiment 49

A catalyst article according to any preceding embodiment, comprising terminals across which a voltage can be applied in order to electrically heat the article.

### Further Embodiment 50

A catalytic metal fiber comprising a core comprising a first metal selected from the group consisting of aluminum, aluminum alloy, copper, copper alloy, stainless steel, nickel, nickel/chromium alloy, iron/chromium alloy and noble metals and a shell comprising a catalytic metal selected from the group consisting of noble metals.

### Further Embodiment 51

A metal fiber according to any preceding embodiment, wherein the diameter of the metal fiber is about 1 μm, about 2 μm, about 3 μm, about 4 μm, about 5 μm, about 6 μm, about 7 μm, about 8 μm, about 9 μm, or about 10 μm, on average; or about 10 μm, about 20 μm, about 30 μm, about 40 μm, about 50 μm, about 60 μm, about 70 μm, about 80 μm, about 90 μm, about 100 μm, about 110 μm, about 120 μm, about 130 μm, about 140 μm or about 150 μm, on average.

### Further Embodiment 52

A metal fiber according to any preceding embodiment, wherein the shell is about 1 nm, about 2 nm, about 3 nm, about 4 nm, about 5 nm, about 6 nm, about 7 nm, about 8 nm, about 9 nm, or about 10 nm, thick, on average; or where the shell is about 10 nm, about 20 nm, about 30 nm, about 40 nm, about 50 nm, about 60 nm, about 70 nm, about 80 nm, about 90 nm, or about 100 nm thick, on average.

### Further Embodiment 53

A metal fiber according to any preceding embodiment, wherein the shell comprises a metal component selected from the group consisting of Pt, Pd, Rh, Au, Ag, Ru, Ir and alloys thereof.

### Further Embodiment 54

A metal fiber according to any preceding embodiment, wherein the shell further comprises a base metal; for example a base metal selected from the group consisting of Cu, Fe, Ni, Cr, Mo, Mn, Zn, Co, W and Al.

### Further Embodiment 55

A metal fiber according to any preceding embodiment, wherein the shell comprises a Pt, Pd or Rh component or mixtures thereof.

### Further Embodiment 56

A metal fiber according to any preceding embodiment, comprising a FeCr alloy core and a shell comprising Pt and or Pd.

### Further Embodiment 57

A metal fiber according to any preceding embodiment, wherein the shell comprises more than one layer, such as wherein the shell comprises at least two different layers; for example a layer comprising a noble metal and a layer comprising a noble metal and a base metal.

### Further Embodiment 58

An exhaust gas treatment system comprising an article or a metal felt according to any preceding embodiment.

### Further Embodiment 59

An exhaust gas treatment system according to any preceding embodiment, further comprising a soot filter.

### Further Embodiment 60

An exhaust gas treatment system according to any preceding embodiment, wherein the article is a diesel oxidation catalyst, a selective reduction catalyst, a lean NOx trap, a three-way catalyst, or an ammonia oxidation catalyst.

### Further Embodiment 61

An exhaust gas treatment system according to any preceding embodiment, downstream of and in fluid communication with an internal combustion engine.

### Further Embodiment 62

A system comprising a catalytic fiber, metal felt, catalyst article or system according to any of the preceding embodiments for the removal of noxious or toxic substances from indoor air, from liquid streams (organic or aqueous), for treatment of emissions from stationary industrial processes or for catalysis in chemical reaction processes.

### Further Embodiment 63

A method for treating an exhaust gas stream, comprising passing the exhaust stream through a metal fiber felt, catalyst article or exhaust gas treatment system according to any preceding embodiment.

### Further Embodiment 64

A method for performing a catalytic chemical reaction, for example for performing catalytic hydrogenation, the method comprising performing the reaction in the presence of a metal fiber felt, catalyst article or catalytic fiber according to any preceding embodiment.

### Further Embodiment 65

A method for treating indoor air, liquid streams (organic or aqueous) or emissions from stationary industrial processes, the method comprising passing the air or liquid streams or emissions through an article or system or in the presence of a metal fiber felt or catalytic fiber according to any preceding embodiment

### Further Embodiment 66

A method for preparing the metal fiber felts, catalyst articles or catalytic fibers according to any of the preceding metal fiber felt, catalyst article or catalytic fiber embodiments/claims, the method comprising electroplating or electroless deposition of one or more noble metals or noble metals and base metals onto metal fibers comprising a first metal selected from the group consisting of aluminum, aluminum alloy, copper, copper alloy, stainless steel, nickel, nickel/chromium alloy, iron/chromium alloy and noble metals.

Unless otherwise indicated, all parts and percentages are by weight. Weight percent (wt %), if not otherwise indicated, is based on an entire composition free of any volatiles, that is, based on dry solids content. All U.S. patent applications, published patent applications and patents referred to herein are hereby incorporated by reference.

### EXPERIMENTAL

### Example 1

An initial composite fiber is formed by inserting a FeCr alloy rod into a tube of platinum. The initial core/shell composite is mechanically reduced to produce an intermediate composite fiber. The intermediate fibers are cut and are further mechanically reduced to produce fibers having a FeCr alloy core and a Pt shell with an average diameter of about 3 microns and a Pt shell having an average thickness of about 4 to about 5 nanometers.

The catalytically active core/shell fibers are combined with 50% by weight FeCr alloy reinforcing fibers having an average diameter of about 20 microns, based on the weight of the total fibers. The core/shell and reinforcing fibers are combined into a random non-woven array and compressed into a metal fiber felt having an average thickness of about 250 microns. The metal fiber felt is corrugated, cut, layered with secluding FeCr alloy foil, coiled and inserted into a metal jacket having dimensions of 1″ diameter by 3″ long.

### Example 2

An initial composite fiber is formed by inserting an Ag rod into a tube of platinum. The initial core/shell composite is mechanically reduced to produce an intermediate composite fiber. The intermediate fibers are cut and are further mechanically reduced to produce fibers having a Ag core and a Pt shell with an average diameter of about 3 microns and a Pt shell having an average thickness of about 4 to about 5 nanometers.

The catalytically active core/shell fibers are combined with 50% by weight FeCr alloy reinforcing fibers having an average diameter of about 20 microns, based on the weight of the total fibers. The core/shell and reinforcing fibers are combined into a random non-woven array and compressed into a metal fiber felt having an average thickness of about 250 microns. The metal fiber felt is corrugated, cut, layered with secluding FeCr alloy foil, coiled and inserted into a metal jacket having dimensions of 1″ diameter by 3″ long.

### Example 3

An initial composite fiber is formed by inserting a Ni rod into a tube of platinum. The initial core/shell composite is mechanically reduced to produce an intermediate composite fiber. The intermediate fibers are cut and are further mechanically reduced to produce fibers having a Ni core and a Pt shell with an average diameter of about 3 microns and a Pt shell having an average thickness of about 4 to about 5 nanometers.

The catalytically active core/shell fibers are combined with 50% by weight FeCr alloy reinforcing fibers having an average diameter of about 20 microns, based on the weight of the total fibers. The core/shell and reinforcing fibers are combined into a random non-woven array and compressed into a metal fiber felt having an average thickness of about 250 microns. The metal fiber felt is corrugated, cut, layered with secluding FeCr alloy foil, coiled and inserted into a metal jacket having dimensions of 1″ diameter by 3″ long.

### Example 4

An initial composite fiber is formed by inserting a Cu rod into a tube of platinum. The initial core/shell composite is mechanically reduced to produce an intermediate composite fiber. The intermediate fibers are cut and are further mechanically reduced to produce fibers having a Cu core and a Pt shell with an average diameter of about 3 microns and a Pt shell having an average thickness of about 4 to about 5 nanometers.

The catalytically active core/shell fibers are combined with 50% by weight FeCr alloy reinforcing fibers having an average diameter of about 20 microns, based on the weight of the total fibers. The core/shell and reinforcing fibers are combined into a random non-woven array and compressed into a metal fiber felt having an average thickness of about 250 microns. The metal fiber felt is corrugated, cut, layered with secluding FeCr alloy foil, coiled and inserted into a metal jacket having dimensions of 1″ diameter by 3″ long.

### Example 5

The metal felt monolith of Example 1 comprising Pt clad FeCr alloy fibers is coated with an aqueous slurry containing Beta zeolite using standard washcoating techniques known in the art. The coated article is then dried at 120° C. and calcined in air at 450° C. The loading of zeolite deposited on the fibers and within the voids of the felt is approximately 0.75 g/in³ of monolith volume.

Many modifications and other implementations of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific implementations disclosed, and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A metal fiber felt comprising a woven or nonwoven mixture of fibers in the form of a corrugated felt comprising a first plurality of core/shell catalytic metal fibers, wherein the catalytic metal fibers comprise a core comprising a first metal and a shell comprising a catalytic metal, the catalytic metal being a noble metal, a base metal, or a combination thereof.

2. The metal fiber felt of claim 1, wherein the mixture of fibers further comprises a second plurality of reinforcing fibers, wherein the average diameter of the reinforcing fibers is greater than the average diameter of the catalytic metal fibers.

3. The metal fiber felt of claim 2, wherein the average diameter of the catalytic metal fibers is about 10 microns or less and the average diameter of the reinforcing fibers is about 15 microns or greater.

4. The metal fiber felt of claim 3, wherein the average diameter of the catalytic metal fibers is about 5 microns or less and the average diameter of the reinforcing fibers is about 20 microns or greater.

5. The metal fiber felt of claim 2, wherein the reinforcing fibers comprise a metal selected from the group consisting of aluminum, aluminum alloy, copper, copper alloy, stainless steel, nickel, nickel/chromium alloy, and iron/chromium alloy.

6. The metal fiber felt of claim 1, wherein the first metal is selected from the group consisting of aluminum, aluminum alloy, copper, copper alloy, stainless steel, nickel, nickel/chromium alloy, iron/chromium alloy, and noble metals.

7. The metal fiber felt of claim 1, wherein the shell of the catalytic fibers have an average thickness of about 100 nm or less.

8. The metal fiber felt of claim 1, wherein the shell of the catalytic fibers comprises a base metal and a noble metal.

9. The metal fiber felt of claim 1, wherein the base metal is selected from the group consisting of Cu, Fe, Ni, Cr, Mo, Mn, Zn, Co, W, and Al.

10. The metal fiber felt of claim 1, wherein the plurality of catalytic metal fibers comprises a first group of fibers having a shell comprising a first noble metal or base metal and a second group of fibers having a shell comprising a second noble metal or base metal.

11. The metal fiber felt of claim 10, wherein the first noble metal is Rh and the second noble metal is Pd.

12. The metal fiber felt of claim 1, wherein the noble metal is selected from the group consisting of Pt, Pd, Rh, and mixtures thereof.

13. The metal fiber felt of claim 1, wherein the metal fiber felt has a void volume of about 20% to about 95%.

14. The metal fiber felt of claim 1, further comprising a catalytic and/or sorbent coating carried by the mixture of fibers.

15. The metal fiber felt of claim 1, wherein the metal fiber felt is substantially free of added catalytic coating or sorbent coating.

16. A catalytic article comprising a three dimensional matrix comprising a plurality of layers of the metal fiber felt of claim 1.

17. The catalytic article of claim 16, wherein the three dimensional matrix comprises a plurality of corrugated layers of the metal fiber felt with flat metal layers therebetween.

18. The catalytic article of claim 17, wherein at least one of the metal fiber felt layers or the flat metal layers carries a catalytic coating or sorbent coating.

19. The catalytic article of claim 17, wherein the flat metal layers are either also formed of the metal fiber felt or formed of a metal foil.

20. The catalytic article of claim 16, further comprising a jacket encasing the three dimensional matrix therein.

21. The catalytic article of claim 16, having a cell density of from about 60 cells per square inch (cpsi) to about 900 cpsi.

22. The catalytic article of claim 16, in the form of a flow-through article or a wall-flow filter.

23. The catalytic article of claim 16, further comprising a heating element operatively positioned to heat the three dimensional matrix or electrical terminals electrically connected to at least one component of the catalytic article and adapted to deliver current for resistive heating of the catalytic article.

24. An exhaust gas treatment system comprising the catalytic article of claim 16 downstream of, and in fluid communication with, an internal combustion engine.

25. The exhaust gas treatment system of claim 24, wherein the catalytic article is selected from the group consisting of a diesel oxidation catalyst, a selective reduction catalyst, a lean NOx trap, a three-way catalyst, and an ammonia oxidation catalyst.

26. A method for treating an exhaust gas stream, comprising passing the exhaust stream through the metal fiber felt of claim 1.
